(19) United States
(12) Patent Application Publication
(10) Pub. No.: US 2025/0136227 A1
(43) Pub. Date: May 1, 2025

(54) NOTIFICATION SYSTEM, NOTIFICATION METHOD, AND COMPUTER PROGRAM

(71) Applicant: YAMAHA HATSUDOKI KABUSHIKI KAISHA, Iwata-shi (JP)

(72) Inventors: Ryuji INOUE, Shizuoka (JP); Kazuya ARIMATSU, Shizuoka (JP); Hirotoshi KUROSU, Shizuoka (JP); Nanami MITSUNARI, Schiphol-Rijk (NL); Masaki SATO, Shizuoka (JP)

(21) Appl. No.: 18/928,659

(22) Filed: Oct. 28, 2024

(30) Foreign Application Priority Data
Oct. 30, 2023 (JP) 2023-185884

(51) Int. Cl. B62J 50/22; B60L 58/13; H04W 4/40

(52) U.S. Cl. CPC B62J 50/22; B60L 58/13; H04W 4/40; B60L 2200/46; B60L 2240/622; B60L 2250/10; B60L 2250/16; B60L 2260/54

(57) ABSTRACT

A notification system for issuing a notification to urge a user to charge a battery of an electric vehicle includes a processor configured or programmed to acquire first border information representing a first border between a first area, encompassing a predetermined point where the battery is chargeable, and an area outward of the first area; acquire positional information representing a current position of the electric vehicle and battery remaining capacity information representing a battery remaining capacity of the battery; and, in a case it is determined that the electric vehicle is inside the first area and the battery remaining capacity is not larger than a first threshold value based on the first border information, the positional information, and the battery remaining capacity information, issue a first notification via a notifier urging the user to charge the battery.

### CROSS REFERENCE TO RELATED APPLICATIONS

This application claims the benefit of priority to Japanese Patent Application No. 2023-185884 filed on Oct. 30, 2023. The entire contents of this application are hereby incorporated herein by reference.

### BACKGROUND OF THE INVENTION

### 1. Field of the Invention

The present invention relates to notification systems, notification methods, and non-transitory computer readable media including computer programs.

### 2. Description of the Related Art

Bicycles are widely used by a variety of people regardless of the age or gender as easy-to-use means of transportation. Recently, electrically assisted bicycles, by which power of users performing pedaling is assisted by electric motors, are increasingly common (see, for example, Japanese Laid-Open Patent Publication No. 2007-230411).

Such an electric motor generates drive power by being supplied with electric power from a battery mounted on a vehicle such as an electrically assisted bicycle. An electrically assisted bicycle causes the electric motor to generate drive power corresponding to the power of a human body, specifically, the power provided by a user to pedals, and thus alleviates the load imposed on the user while, for example, traveling on a slope or traveling with a cargo.

### SUMMARY OF THE INVENTION

The electric power is supplied from the battery to the electric motor, and thus the remaining capacity of the battery gradually decreases. The battery, when having a small remaining capacity, may be charged to be repeatedly used. If the user does not charge the battery and the battery remaining capacity decreases to zero or a value close to zero, the electric motor cannot generate assist power.

An electric vehicle such as an electrically assisted bicycle is required to, when the battery remaining capacity decreases to a small value, notify the user of this situation such that the user can charge the battery.

In the case where the electric vehicle gets far from the point where the battery is chargeable, the battery remaining capacity may become zero before the electric vehicle arrives back at the point. The electric vehicle is required to notify the user that there is such a possibility.

Example embodiments of the present invention disclose notification systems, notification methods, and non-transitory computer readable mediums including computer programs as described below.

A notification system for issuing a notification to urge a user to charge a battery of an electric vehicle includes a processor and a storage to store a computer program to control an operation of the processor, wherein, the processor is configured or programmed to execute the computer program to acquire first border information representing a first border between a first area, encompassing a predetermined point where the battery is chargeable, and an area outward of the first area, acquire positional information representing a current position of the electric vehicle and battery remaining capacity information representing a battery remaining capacity of the battery, and in a case it is determined that the electric vehicle is located inside the first area and that the battery remaining capacity is not larger than a first threshold value based on the first border information, the positional information, and the battery remaining capacity information, issue a first notification via a notifier urging the user to charge the battery.

In the case where the battery remaining capacity is not larger than the first threshold value, the first notification urging the user to charge the battery may be issued at a timing when the electric vehicle gets close to the predetermined point where the battery is chargeable. This allows the user to keep in mind that he/she has to charge the battery when arriving at the predetermined point.

If the first notification is issued when the electric vehicle arrives at the predetermined point, the following may occur. If the actual position of the electric vehicle is deviated from the position represented by the positional information, the first notification may not be issued even though the electric vehicle arrives at the predetermined point. According to an example embodiment of the present invention, the first notification is issued while the electric vehicle is located inside the first area, which has a large area. Therefore, even if the actual position of the electric vehicle is deviated from the position represented by the positional information, the first notification may be issued.

The first notification is issued in the case where the battery remaining capacity is not larger than the first threshold value, so that the uneasiness that the user feels regarding the possibility that the battery remaining capacity becomes zero without him/her noticing may be alleviated.

In the notification system above, wherein in a case it is determined that the electric vehicle has passed a position of the first border into the first area from the area outward of the first area and that the battery remaining capacity is not larger than the first threshold value, the processor is configured or programmed to issue the first notification.

With this arrangement, the first notification may be issued at the timing when the electric vehicle gets close to the predetermined point. This allows the user to keep in mind that he/she has to charge the battery when arriving at the predetermined point.

The first notification is issued when the electric vehicle passes the first border, which is spaced away from the predetermined point by a certain distance. Therefore, even if the actual position of the electric vehicle is deviated from the position represented by the positional information, the first notification is issued.

In the notification system above, wherein in a case it is determined that the electric vehicle has passed the position of the first border into the first area from the area outward of the first area and that the battery remaining capacity is larger than the first threshold value, the processor is configured or programmed to not issue the first notification.

With this arrangement, the notification is not issued in the case where there is no need to charge the battery in a hurry.

In the notification system above, wherein in a case where the processor does not issue the first notification when the electric vehicle passes the position of the first border but later determines that the battery remaining capacity is decreased to a value not larger than the first threshold value while the electric vehicle is located inside the first area, the processor is configured or programmed to issue the first notification.

With this arrangement, even in the case where the first notification is not issued when the electric vehicle passes the position of the first border, if, after that, the battery remaining capacity is decreased to a value not larger than the first threshold value, the first notification may be issued at a position close to the predetermined point.

In the notification system above, at least a portion of the first border is spaced away from the predetermined point by a first distance.

With this arrangement, the first notification may be issued before the electric vehicle arrives at the predetermined point. This allows the user to keep in mind that he/she has to charge the battery when arriving at the predetermined point.

In the notification system above, the first distance is about 50 meters or longer and about 200 meters or shorter.

With this arrangement, the first notification may be issued before (e.g., several tens of seconds before) the electric vehicle arrives at the predetermined point.

In the notification system above, the first border defines a circle centered around the predetermined point on a map.

With this arrangement, the first notification may be issued at a common timing regardless of the direction in which the electric vehicle approaches the predetermined point.

In the notification system above, the battery remaining capacity is represented by SOC (State of Charge), and the first threshold value is set to an SOC value of about 20% or higher and about 60% or lower.

With this arrangement, the first notification may be issued at a timing when it is recommended to charge the battery.

In the notification system above, the processor is configured or programmed to acquire second border information representing a second border located along an outer perimeter of a second area enclosing the first area, and in a case it is determined that the electric vehicle has passed a position of the second border into an area outward of the second area from the second area, issues a second notification via the notifier urging the user to move the electric vehicle to the predetermined point.

In the case where the electric vehicle gets far from the predetermined point where the battery is chargeable, the battery remaining capacity may undesirably become zero before the electric vehicle arrives back at the predetermined point. In the case where the electric vehicle has passed the position of the second border into the area outward of the second area, a notification urging the user to move the electric vehicle to the predetermined point is issued. This allows the user to recognize that if the electric vehicle is farther away from the predetermined point, the battery remaining capacity may possibly become zero before the electric vehicle arrives back at the predetermined point.

In the notification system above, the processor is configured or programmed to calculate, based on the battery remaining capacity, a second distance by which the electric vehicle is able to travel with an output current from the battery, and set the position of the second border such that a third distance D3 between the predetermined point and the second border is shorter than the second distance.

With this arrangement, the possibility that the battery remaining capacity becomes zero before the electric vehicle arrives back at the predetermined point may be decreased.

In the notification system above, the processor is configured or programmed to change the position of the second border in accordance with a change in the battery remaining capacity.

With this arrangement, the second border may be set at the position suitable to the current battery remaining capacity.

In the notification system above, the processor is configured or programmed to set the position of the second border such that the third distance is at least about 0.3 times and at most about 0.7 times the second distance.

With this arrangement, the possibility that the battery remaining capacity becomes zero before the electric vehicle arrives back at the predetermined point may be decreased.

In the notification system above, the notifier is included in a mobile terminal device, and the electric vehicle and the mobile terminal device communicate information with each other by wireless communication.

With this arrangement, the first notification urging the user to charge the battery may be issued by the mobile terminal device. This makes it unnecessary to mount the notifier on the electric vehicle.

In the notification system above, the processor and the storage are included in a mobile terminal device, and the battery remaining capacity information is sent from the electric vehicle to the mobile terminal device by wireless communication.

The mobile terminal device executes a process of determining whether or not to issue the first notification. This makes it unnecessary to mount the device executing such a process on the electric vehicle.

In the notification system above, the notifier includes a display, and the processor is configured or programmed to cause the display to display at least one of a letter or a graphic pattern as the first notification urging the user to charge the battery.

With this arrangement, the user looks at the display contents of the display and thus may keep in mind that he/she has to charge the battery when arriving at the predetermined point.

In the notification system above, the notifier includes a sound production component, and the processor is configured or programmed to cause the sound production component to output a sound as the first notification urging the user to charge the battery.

With this arrangement, the user hears the sound output by the sound production component and thus may keep in mind that he/she has to charge the battery when arriving at the predetermined point.

In the notification system above, the predetermined point is a point where a charging device charging the battery is located.

With this arrangement, the battery may be charged at the predetermined point.

In the notification system above, the electric vehicle is an electrically assisted bicycle including an electric motor supplied with an electric current from the battery to generate assist power.

With this arrangement, the user may keep in mind that he/she has to charge the battery of the electrically assisted bicycle when arriving at the predetermined point.

In the notification system above, the battery is a portable battery detachable from the electric vehicle.

With this arrangement, the battery may be charged in a state of being detached from the electric vehicle.

A notification method for issuing a notification urging a user to charge a battery of an electric vehicle, the notification method being executable by at least one computer and including acquiring first border information representing a first border between a first area, encompassing a predetermined point where the battery is chargeable, and an area outward of the first area; acquiring positional information representing a current position of the electric vehicle and battery remaining capacity information representing a battery remaining capacity of the battery; and in a case where it is determined that the electric vehicle is located inside the first area and that the battery remaining capacity is not larger than a first threshold value based on the first border information, the positional information, and the battery remaining capacity information, issuing a first notification via a notifier urging the user to charge the battery.

In the case where the battery remaining capacity is not larger than the first threshold value, the first notification urging the user to charge the battery may be issued at the timing when the electric vehicle gets close to the predetermined point where the battery is chargeable. This allows the user to keep in mind that he/she has to charge the battery when arriving at the predetermined point.

If the first notification is issued when the electric vehicle arrives at the predetermined point, the following may occur. If the actual position of the electric vehicle is deviated from the position represented by the positional information, the first notification may not be issued even though the electric vehicle arrives at the predetermined point. According to an example embodiment of the present invention, the first notification is issued while the electric vehicle is located inside the first area, which has a large area. Therefore, even if the actual position of the electric vehicle is deviated from the position represented by the positional information, the first notification may be issued.

The first notification is issued in the case where the battery remaining capacity is not larger than the first threshold value so that the uneasiness that the user feels regarding the possibility that the battery remaining capacity becomes zero without him/her noticing may be alleviated.

A non-transitory computer readable medium including a computer program to cause at least one computer to issue a notification urging charging of a battery of an electric vehicle, the computer program causing the at least one computer to acquire first border information representing a first border between a first area, encompassing a predetermined point where the battery is chargeable, and an area outward of the first area; acquire positional information representing a current position of the electric vehicle and battery remaining capacity information representing a battery remaining capacity of the battery; and in a case where it is determined that the electric vehicle is located inside the first area and that the battery remaining capacity is not larger than a first threshold value based on the first border information, the positional information, and the battery remaining capacity information, issue a first notification via a notifier urging the user to charge the battery.

In the case where the battery remaining capacity is not larger than the first threshold value, the first notification urging the user to charge the battery may be issued at the timing when the electric vehicle gets close to the predetermined point where the battery is chargeable. This allows the user to keep in mind that he/she has to charge the battery when arriving at the predetermined point.

If the first notification is issued when the electric vehicle arrives at the predetermined point, the following may occur. If the actual position of the electric vehicle is deviated from the position represented by the positional information, the first notification may not be issued even though the electric vehicle arrives at the predetermined point. According to an example embodiment of the present invention, the first notification is issued while the electric vehicle is located inside the first area, which has a large area. Therefore, even if the actual position of the electric vehicle is deviated from the position represented by the positional information, the first notification may be issued.

The first notification is issued in the case where the battery remaining capacity is not larger than the first threshold value so that the uneasiness that the user feels regarding the possibility that the battery remaining capacity becomes zero without him/her noticing may be alleviated.

A notification system for issuing a notification about a battery of an electric vehicle to a user includes a processor and a storage to store a computer program to control an operation of the processor, wherein the processor is configured or programmed to execute the computer program to acquire border information representing a border located along an outer perimeter of a predetermined area enclosing a predetermined point where the battery is chargeable, and positional information representing a current position of the electric vehicle; and in a case it is determined that the electric vehicle has passed a position of the border into an area outward of the predetermined area from the predetermined area based on the border information and the positional information, issue a notification via a notifier urging the user to move the electric vehicle to the predetermined point.

In the case where the electric vehicle gets far from the predetermined point where the battery is chargeable, the battery remaining capacity may undesirably become zero before the electric vehicle arrives back at the predetermined point. In the case where the electric vehicle has passed the position of the border into the area outward of the predetermined area, a notification urging the user to move the electric vehicle to the predetermined point is issued. This allows the user to recognize that if the electric vehicle is farther away from the predetermined point, the battery remaining capacity may possibly become zero before the electric vehicle arrives back at the predetermined point.

In the notification system above, the processor is configured or programmed to acquire battery remaining capacity information representing a battery remaining capacity of the battery, calculate, based on the battery remaining capacity, a distance-to-empty by which the electric vehicle is able to travel with an output current from the battery, and set the position of the border such that a distance between the predetermined point and the border is shorter than the distance-to-empty.

With this arrangement, the possibility that the battery remaining capacity becomes zero before the electric vehicle arrives back at the predetermined point may be decreased.

In the notification system above, the processor is configured or programmed to change the position of the border in accordance with a change in the battery remaining capacity.

With this arrangement, the border may be set at the position suitable to the current battery remaining capacity.

In the notification system above, the processor is configured or programmed to set the position of the border such that the distance between the predetermined point and the border is at least about 0.3 times and at most about 0.7 times the distance-to-empty.

With this arrangement, the possibility that the battery remaining capacity becomes zero before the electric vehicle arrives back at the predetermined point may be decreased.

A notification method for making a notification about a battery of an electric vehicle to a user, the notification method being executable by at least one computer and including acquiring border information representing a border located along an outer perimeter of a predetermined area enclosing a predetermined point where the battery is chargeable, and positional information representing a current position of the electric vehicle; and in a case where it is determined that the electric vehicle has passed a position of the border into an area outward of the predetermined area from the predetermined area based on the border information and the positional information, issuing a notification via a notifier urging the user to move the electric vehicle to the predetermined point.

In the case where the electric vehicle gets far from the predetermined point where the battery is chargeable, the battery remaining capacity may undesirably become zero before the electric vehicle arrives back at the predetermined point. In the case where the electric vehicle has passed the position of the border into the area outward of the predetermined area, a notification urging the user to move the electric vehicle to the predetermined point is issued. This allows the user to recognize that if the electric vehicle is farther away from the predetermined point, the battery remaining capacity may possibly become zero before the electric vehicle arrives back at the predetermined point.

A non-transitory computer readable medium including a computer program to cause at least one computer to issue a notification about a battery of an electric vehicle, the computer program causing the at least one computer to acquire border information representing a border located along an outer perimeter of a predetermined area enclosing a predetermined point where the battery is chargeable, and positional information representing a current position of the electric vehicle; and in a case where it is determined that the electric vehicle has passed a position of the border into an area outward of the predetermined area from the predetermined area based on the border information and the positional information, issue a notification via a notifier urging the user to move the electric vehicle to the predetermined point.

In the case where the electric vehicle gets far from the predetermined point where the battery is chargeable, the battery remaining capacity may undesirably become zero before the electric vehicle arrives back at the predetermined point. In the case where the electric vehicle has passed the position of the border into the area outward of the predetermined area, a notification urging the user to move the electric vehicle to the predetermined point is issued. This allows the user to recognize that if the electric vehicle is farther away from the predetermined point, the battery remaining capacity may possibly become zero before the electric vehicle arrives back at the predetermined point.

According to an example embodiment of the present invention, in the case where the battery remaining capacity is not larger than the first threshold value, the first notification urging the user to charge the battery may be issued at the timing when the electric vehicle gets close to the predetermined point where the battery is chargeable. This allows the user to keep in mind that he/she has to charge the battery when arriving at the predetermined point.

If the first notification is issued when the electric vehicle arrives at the predetermined point, the following may occur. If the actual position of the electric vehicle is deviated from the position represented by the positional information, the first notification may not be issued even though the electric vehicle arrives at the predetermined point. According to an example embodiment of the present invention, the first notification is issued while the electric vehicle is located inside the first area, which has a large area. Therefore, even if the actual position of the electric vehicle is deviated from the position represented by the positional information, the first notification may be issued.

The first notification is issued in the case where the battery remaining capacity is not larger than the first threshold value so that the uneasiness that the user feels regarding the possibility that the battery remaining capacity becomes zero without him/her noticing may be alleviated.

In the case where the electric vehicle gets far from the predetermined point where the battery is chargeable, the battery remaining capacity may undesirably become zero before the electric vehicle arrives back at the predetermined point. According to an example embodiment of the present invention, in the case where the electric vehicle has passed the position of the border into the area outward of the predetermined area, a notification urging the user to move the electric vehicle to the predetermined point is issued. This allows the user to recognize that if the electric vehicle is farther away from the predetermined point, the battery remaining capacity may possibly become zero before the electric vehicle arrives back at the predetermined point.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a right side view of an electrically assisted bicycle 1 according to an example embodiment of the present invention.

FIG. 2 is a plan view of a front portion of the electrically assisted bicycle 1 according to an example embodiment of the present invention.

FIG. 3 is a block diagram showing an example of hardware configuration of a meter 50 according to an example embodiment of the present invention.

FIG. 4 is a block diagram showing an example of hardware configuration of a mobile terminal device 100 according to an example embodiment of the present invention.

FIG. 5 shows how a battery unit 20 is attached to, or detached from, the electrically assisted bicycle 1 according to an example embodiment of the present invention.

FIG. 6 shows an example of setting a battery charging point according to an example embodiment of the present invention.

FIG. 7 shows an example of a first border according to an example embodiment of the present invention.

FIG. 8 is a flowchart showing an example of an operation of issuing a first notification urging a user to charge a battery according to an example embodiment of the present invention.

FIG. 9 shows a state where the electrically assisted bicycle 1 is inside a first area 131 according to an example embodiment of the present invention.

FIG. 10 shows an example of the mobile terminal device 100 issuing the first notification according to an example embodiment of the present invention.

FIG. 11 is a flowchart showing another example of an operation of issuing the first notification urging the user to charge a battery according to an example embodiment of the present invention.

FIG. 12 shows an example of meter 50 issuing the first notification according to an example embodiment of the present invention.

FIG. 13 shows an example of second area 132 and second border 142 according to an example embodiment of the present invention.

FIG. 14 is a flowchart showing an example of an operation of issuing a second notification urging the user to move the electrically assisted bicycle 1 to a battery charging point 125 according to an example embodiment of the present invention.

FIG. 15 shows a state where the electrically assisted bicycle 1 is in an area outward of the second area 132 according to an example embodiment of the present invention.

FIG. 16 shows an example of the mobile terminal device 100 issuing the second notification according to an example embodiment of the present invention.

FIG. 17 shows an example of the meter 50 issuing the second notification according to an example embodiment of the present invention.

### DETAILED DESCRIPTION OF THE EXAMPLE EMBODIMENTS

Hereinafter, example embodiments of the present invention will be described with reference to the drawings. In the description of the example embodiments, like elements will bear like reference signs, and overlapping descriptions will be omitted. In the drawings, letters F, Re, L, R, U and D respectively indicate front, rear, left, right, up and down. The “front-rear”, “left-right” and “up-down” directions regarding an electric vehicle respectively indicate front-rear, left-right and up-down directions for a user sitting on a seat (saddle) of the vehicle while facing a handle. In the following description, an electrically assisted bicycle will be described as an example of electric vehicle, but the electric vehicle of the present invention is not limited to the electrically assisted bicycle. The electric vehicle according to an example embodiment of the present invention may be, for example, an electric bicycle or an electric tricycle having an electric motor as a source of drive power. The following example embodiments are merely illustrative, and do not limit the present invention in any way.

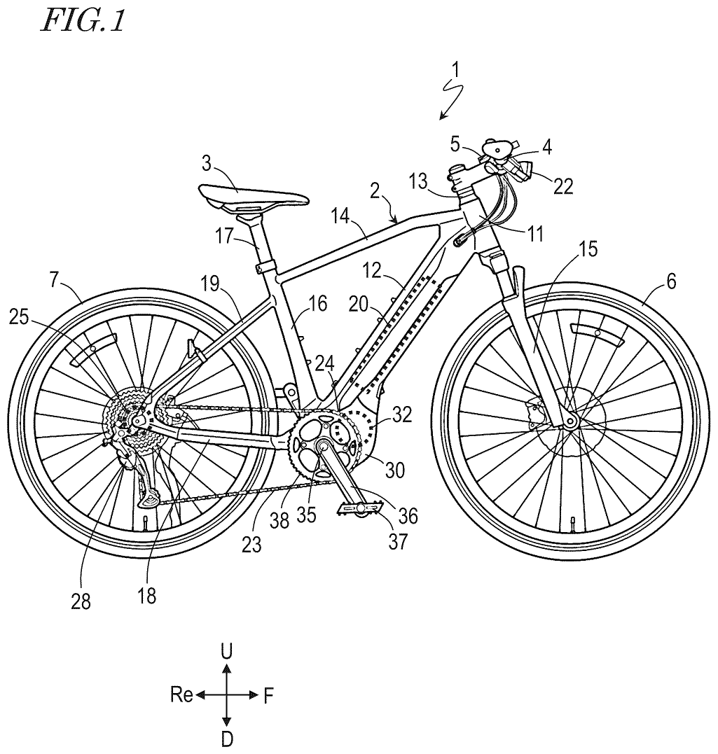

FIG. 1 is a right side view of an electrically assisted bicycle 1 according to an example embodiment of the present invention. In the following description, the electrically assisted bicycle 1 may also be referred to simply as a “bicycle 1”.

The electrically assisted bicycle 1 includes a body frame 2 extending in a front-rear direction. The body frame 2 includes a head pipe 11, a down tube 12, a top tube 14, a seat tube 16, a chain stay 18, a seat stay 19, and a bracket 24. The head pipe 11 is located at a front end of the body frame 2. A handle column 13 is rotatably inserted into the head pipe 11. A handle 4 is secured to the handle column 13. A meter unit 5 displaying various types of information on the electrically assisted bicycle 1 is provided on the handle 4. A head lamp 22 is provided on the front of the handle 4.

A front fork 15 is secured to a bottom end of the handle column 13. A bottom end of the front fork 15 supports a front wheel 6, which is a steering wheel, such that the front wheel 6 is rotatable.

The down tube 12 extends obliquely rearward and downward from the head pipe 11. The seat tube 16 extends upward from a rear end of the down tube 12. The chain stay 18 extends rearward from a bottom end of the seat tube 16. The bracket 24 connects the rear end of the down tube 12, the bottom end of the seat tube 16 and a front end of the chain stay 18 to each other. The top tube 14 connects a top portion of the head pipe 11 and a top portion of the seat tube 16 to each other. A seat post 17 is inserted into the seat tube 16. The saddle 3, on which the user may sit, is provided at a top end of the seat post 17.

A rear end of the chain stay 18 supports a rear wheel 7, which is a driving wheel, such that the rear wheel 7 is rotatable. The seat stay 19 extends obliquely rearward and downward from the top portion of the seat tube 16. A bottom end of the seat stay 19 is connected with the rear end of the chain stay 18. A transmission 28 to change the transmission gear ratio is provided at the rear end of the chain stay 18. The transmission may be provided in the vicinity of a pedal crank shaft 35. A speed sensor 25, which detects the rotation rate of the rear wheel 7, is provided on a rear portion of the chain stay 18. The speed sensor 25 may be provided on a bottom portion of the front fork 15 to detect the rotation rate of the front wheel 6.

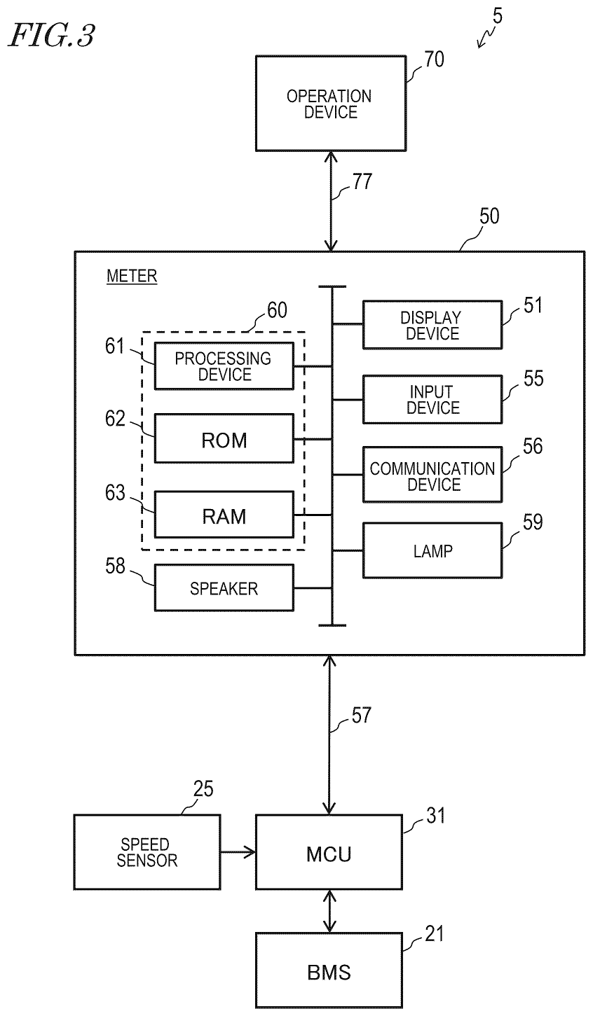

The bracket 24 located in the vicinity of a vehicle center of the body frame 2 is provided with a drive unit 30. A housing of the drive unit 30 houses an electric motor 32, an MCU (motor control unit) 31 (see FIG. 3), a decelerator, and the like. The pedal crankshaft 35 is supported by extending through the drive unit 30 in a left-right direction. Crankarms 36 are respectively provided at both of two ends of the pedal crankshaft 35. Pedals 37 are rotatably provided respectively at tips of the crankarms 36.

A battery unit 20 supplying electric power to the drive unit 30 or the like is mounted on the down tube 12. In the example shown in FIG. 1, the battery unit 20 is provided inside the down tube 12. The down tube 12 may be hollow. At least a portion of down tube 12 may have a U-shaped cross-section, and the down tube 12 may be provided with a cover covering the U-shaped portion.

The battery unit 20 may be located on an outer surface of the down tube 12. The battery unit 20 may be mounted on the bracket 24 or the seat tube 16. The battery unit 20 may be detachable from the electrically assisted bicycle 1.

The battery unit 20 includes a battery and a BMS (battery management system) 21 (see FIG. 3). The battery is a rechargeable battery. The BMS 21 controls charge/discharge of the battery and monitors an output current, a battery remaining capacity and the like of the battery.

The MCU 31 of the drive unit 30 controls operations of the electric motor 32, and also controls operations of various components of the electrically assisted bicycle 1. The MCU 31 includes a semiconductor integrated circuit such as a processor or the like and a motor driving circuit. A rotation of the pedal crank shaft 35 generated by the user stepping on the pedals 37 is conveyed to the rear wheel 7 via a driving sprocket 38 and a chain 23. The MCU 31 controls the electric motor 32 to generate a driving assisting output corresponding to the rotation output of the pedal crank shaft 35 generated by the user stepping on the pedals 37. Assist power generated by the electric motor 32 is conveyed to the rear wheel 7 via the driving sprocket 38 and the chain 23. Instead of the chain 23, a belt, a shaft or the like may be used.

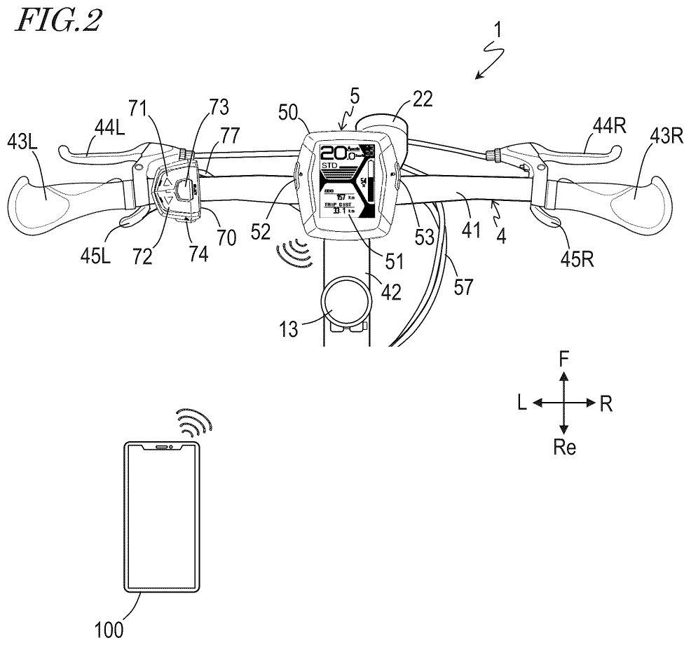

FIG. 2 is a top view showing a front portion of the electrically assisted bicycle 1. The handle 4 includes a handle bar 41. A right grip 43R is provided at a right end of the handle bar 41. A left grip 43L is provided at a left end of the handle bar 41. The user grips the right grip 43R and the left grip 43L with his/her hands to steer the electrically assisted bicycle 1.

A front wheel brake lever 44R and a shift controller 45R are provided in the vicinity of the right grip 43R. A rear wheel brake lever 44L and a shift controller 45L are provided in the vicinity of the left grip 43L. When the right grip 43R and the front wheel brake lever 44R are gripped by the right hand of the user, braking power is supplied to the front wheel 6. When the left grip 43L and the rear wheel brake lever 44L are gripped by the left hand of the user, braking power is supplied to the rear wheel 7. The brake lever provided to the left of the handle bar 41 may be the front wheel brake lever supplying the front wheel 6 with the braking power, and the brake lever provided to the right of the handle bar 41 may be the rear wheel brake lever supplying the rear wheel 7 with the braking power. The shift controllers 45R and 45L are also referred as “shifters”. The user may switch the transmission ratio by operating the shift controllers 45R and 45L.

The handle bar 41 is provided with the meter unit 5. The meter unit 5 includes the meter 50 and an operation device 70.

The meter 50 displays various types of information about the electrically assisted bicycle 1. The meter 50 is attached to the handle bar 41 or a handle stem 42 by use of an attachment tool such as a clamp or the like.

The operation device 70 is provided in the vicinity of, for example, the left grip 43L of the handle 4. The operation device 70 is attached to the handle bar 41 by use of an attachment tool such as a clamp or the like. The user may operate the operation device 70 with his/her fingers to make an operation of, for example, setting the level of the assist power of the electric motor 32. The meter 50 and the operation device 70 are electrically connected with each other via an electric cable 77. A signal in correspondence with the operation made by the user is sent from the operation device 70 to the meter 50 via the electric cable 77. The meter 50 and the MCU 31 of the drive unit 30 (see FIG. 1) may transfer signals to each other via an electric cable 57. The meter 50 and the operation device 70 may transfer signals to each other wirelessly. The meter 50 and the MCU 31 may transfer signals to each other wirelessly.

The meter 50 includes a display 51 to display various types of information about the electrically assisted bicycle 1 and a plurality of switches 52 and 53 accepting operations of the user. The plurality of switches 52 and 53 are, specifically, a power switch 52 and a lamp light switch 53. In this example embodiment, these switches are push-button switches, which are pushed down by the user with his/her finger to be turned on or off.

The power switch 52 turns on or off the power of the electrically assisted bicycle 1. When the power of the electrically assisted bicycle 1 is on, the drive unit 30 operates, whereas when the power of the electrically assisted bicycle 1 is off, the drive unit 30 does not operate. When the user pushes down the power switch 52 while the power is off, the power is turned on. When the user pushes down the power switch 52 while the power is on, the power is turned off.

The lamp light switch 53 turns the head lamp 22 (FIG. 1) on or off. When the user pushes down the lamp light switch 53 while the head lamp 22 is off to turn the head lamp 22 on, the head lamp 22 emits light and illuminate the road ahead of the electrically assisted bicycle 1. When the user pushes down the lamp light switch 53 while the head lamp 22 is on, the head lamp 22 is turned off.

The display 51 includes, for example, a liquid crystal panel. The display 51 may display various types of information such as the traveling speed, the traveling distance, the battery remaining capacity, the assist mode and the like. The display 51 may display such information by a segment system or by a dot-matrix system. A display panel other than the liquid crystal panel, for example, an OLED (Organic Light-Emitting Diode) panel or an electronic paper panel may be used.

The operation device 70 includes assist power setting switches 71 and 72, a select switch 73, and a walk switch 74. The assist power setting switches 71 and 72 set the assist power of the electric motor 32. In this example embodiment, the electrically assisted bicycle 1 may be set to any one of a plurality of assist modes. The plurality of assist modes are, for example, an assist-free mode, an ecological mode, a smart mode, and a high mode, in the order from the mode in which the magnitude of the assist power assisting the power of a human body is lowest. In the assist-free mode, the electric motor 32 does not generate any assist power. When the user pushes down the assist power setting switch 71, an assist mode in which the magnitude of the assist power assisting the power of a human body is relatively low is switched to an assist mode in which such a magnitude is relatively higher. When the user pushes down the assist power setting switch 72, an assist mode in which the magnitude of the assist power assisting the power of a human body is relatively high is switched to an assist mode in which such a magnitude is relatively lower.

In the above-described example, there are four different assist modes. Alternatively, there may be three or less assist modes, or five or more assist modes. For example, there may be an assist mode in which larger assist power than that in the high mode is generated, or there may be a plurality of different types of ecological modes.

The select switch 73 switches display contents of the display 51. The user may push down the select switch 73 to switch the display contents of the display 51.

The walk switch 74 accepts, from the user, an instruction to execute a walk mode. In the walk mode, while the user is walking the electrically assisted bicycle 1, the electric motor 32 is caused to generate assist power. The expression “walking the electrically assisted bicycle 1” refers to that the user pushes and moves the bicycle 1 forward without stepping on the pedals 37. In an example of operation of “walking the electrically assisted bicycle 1”, the user gets off the bicycle 1 and moves the bicycle 1 forward while walking and pushing the handle 4 with his/her hands.

When the user keeps on pushing down the walk switch 74 while walking the electrically assisted bicycle 1, the electric motor 32 generates assist power. The electric motor 32 is caused to generate assist power while the user is walking the electrically assisted bicycle 1, so that the load on the user may be decreased. For example, when the user is walking up a slope while pushing the bicycle 1 with his/her hands, the load on the user may be decreased.

The meter 50 is wirelessly communicable with the mobile terminal device 100, which may be a smartphone or the like. The wireless communication allows the meter 50 and the mobile terminal device 100 to transfer various types of information to each other.

Now, an example of the hardware configuration of the meter 50 will be described. FIG. 3 is a block diagram showing an example of the hardware configuration of the meter 50.

The meter 50 includes a controller 60, the display 51, an input device 55, a communication device 56, a speaker 58, and a lamp 59. These components are connected to each other via a bus so as to be communicable to each other.

The controller 60 includes a processor 61 and storage mediums such as, for example, a ROM (Read Only Memory) 62 and a RAM (Random Access Memory) 63. The ROM 62 may store a computer program (or firmware) that causes the processor 61 to execute processes. The computer program may be stored on the ROM 62 at the time of production of the meter 50. The computer program may be provided to the meter 50 via a storage medium (e.g., a semiconductor memory, an optical disc, or the like) or an electric communication line (e.g., the Internet). Such a computer program may be marketed as commercial software.

The processor 61 may be a semiconductor integrated circuit such as a processor or the like, and includes, for example, a central processing unit (CPU). The processor 61 may be realized by a microprocessor or a microcontroller. The processor 61 is configured or programmed to sequentially execute a computer program describing a group of commands that cause various processes to be executed (computer program stored on the ROM 62) to realize a desired process.

The processor 61 may be an FPGA (Field Programmable Gate Array), a GPU (Graphics Processing Unit), an ASIC (Application Specific Integrated Circuit) or an ASSP (Application Specific Standard Product) each having a CPU mounted thereon, or a combination of two or more selected from these circuits.

The ROM 62 is, for example, a writable memory (e.g., a PROM), a rewritable memory (e.g., a flash memory), or a memory only for reading. As described above, the ROM 62 may store a computer program that causes the processor 61 to execute processes. The ROM 62 further stores a computer program controlling operations of the processor 61. The ROM 62 does not need to be a single storage medium, and may be an assembly of a plurality of storage mediums. A portion of the plurality of storage mediums may be a detachable memory.

The RAM 63 provides a work area in which the computer program stored on the ROM 62 is once developed at the time of booting. The RAM 63 does need to be a single storage medium, and may be an assembly of a plurality of storage mediums.

The communication device 56 is a communication module that communicates with the mobile terminal device 100 or the like. The communication device 56 may perform wired communication and/or wireless communication. The communication device 56 may perform wired communication compliant to a communication protocol such as, for example, USB, IEEE1394 (registered trademark), Ethernet (registered trademark) or the like. The communication device 56 may perform wireless communication compliant to, for example, the Bluetooth (registered trademark) protocols and/or the Wi-Fi (registered trademark) protocols. Either protocol includes a wireless communication protocol using a frequency of the 2.4 GHz band or the 5.0 GHz band. The communication device 56 may be a communication module capable of performing wireless communication compliant to the BLE (Bluetooth Low Energy) communication system or the LPWA (Low Power Wide Area) communication system. The communication device 56 may perform wireless communication using a mobile phone line or a satellite channel.

The input device 55 accepts operations of the user on, for example, the power switch 52 and the lamp light switch 53 described above. The meter 50 may include a touch panel and/or a microphone as the input device 55.

The processor 61 detects that any of the various switches of the meter 50 and the operation device 70 has been pushed down, and controls operations of the display 51. For example, when the user starts pushing down a switch, the processor 61 detects a voltage value and/or a current value of a predetermined level or higher. When the user finishes pushing down the switch, the processor 61 detects that the voltage value and/or the current value that has been detected so far has become, for example, zero. The processor 61 may detect a plurality of switches being pushed down at the same time, in a parallel manner.

In correspondence with any of the various switches of the meter 50 and the operation device 70 being pushed down, the processor 61 controls the display 51 to change the display contents thereof. The drive unit 30 includes the MCU 31. The processor 61 outputs a signal, in correspondence with the switch pushed down, to the MCU 31. For example, the processor 61 outputs a signal representing the selected assist mode to the MCU 31. Upon receipt of the signal, the MCU 31 controls the electric motor 32 to generate assist power in correspondence with the selected assist mode.

An output signal from the speed sensor 25 is input to the MCU 31. The MCU 31 may calculate the traveling speed of the bicycle 1 based on the output signal from the speed sensor 25. The MCU 31 outputs traveling speed information, representing the traveling speed, to the meter 50. Upon receipt of the traveling speed information, the processor 61 controls the display 51 to display the traveling speed. The output signal from the speed sensor 25 may be directly input to the meter 50 without being once output to the MCU 61.

The BMS 21 is mounted on the battery unit 20. The BMS 21 controls various operations of, for example, charging/discharging the battery unit 20, and monitors various states of the battery unit 20. The BMS 21 monitors the voltage, the current, the temperature, the SOC (State of Charge) and the like of the battery unit 20. The MCU 31 and the BMS 21 transfer necessary information to each other. The MCU 31 receives battery information representing the voltage, the current, the temperature, the SOC and the like of the battery unit 20 from the BMS 21.

The MCU 31 outputs SOC information representing the SOC of the battery unit 20 to the meter 50. The processor 61 controls the display 51 to display information on the battery remaining capacity in accordance with the battery remaining capacity calculated based on the SOC information.

The speaker 58 converts an audio signal into a sound and outputs the sound to the outside. The lamp 59 emits light. The processor 61 may control the operations of the display 51, the speaker 58, the lamp 59 or the like to notify the user of information.

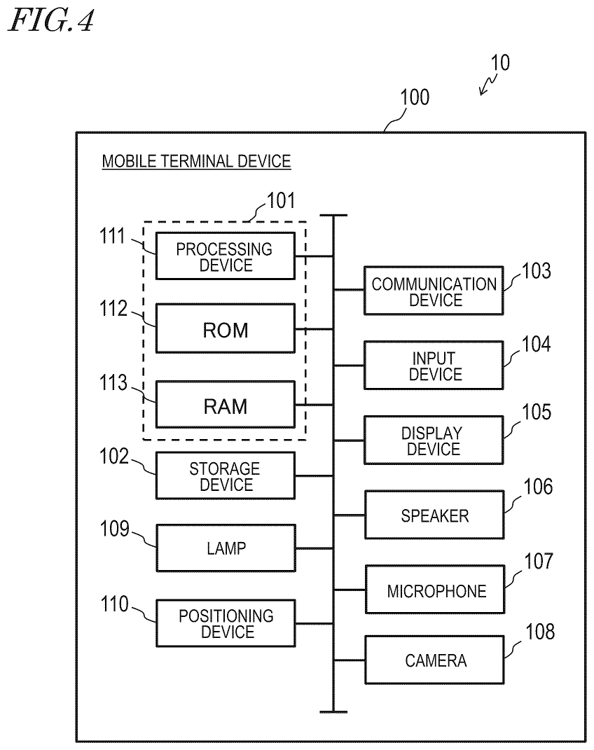

Now, an example of the hardware configuration of the mobile terminal device 100 will be described. FIG. 4 is a block diagram showing an example of the hardware configuration of the mobile terminal device 100. The mobile terminal device 100 is, for example, a smartphone or a tablet computer. The mobile terminal device 100 may be a wearable computer such as a smartwatch, smartglasses or the like.

The mobile terminal device 100 is an example of notification system 10 notifying the user of the information about the battery unit 20 of the electrically assisted bicycle 1. Operations of the notification system 10 will be described in detail below. Hereinafter, an example in which the mobile terminal device 100 is a smartphone will be described.

The mobile terminal device 100 includes a controller 101, a storage 102, a communication device 103, an input device 104, a display 105, a speaker 106, a microphone 107, a camera 108, a lamp 109, and a positioning device 110. These components are connected to each other via a bus so as to be communicable to each other.

The controller 101 includes a processor 111, a ROM 112, and a RAM 113. An explanation on the processor 111, the ROM 112 and the RAM 113 overlaps the explanation on the processor 61, the ROM 62 and the RAM 63 of the meter 50, and thus will not be repeated.

The storage 102 may be, for example, a semiconductor storage, a magnetic storage, an optical storage, or a combination thereof. An example of the semiconductor storage is a solid state drive (SSD). An example of the magnetic storage is a hard disc drive (HDD). An example of the optical storage is an optical disc drive, a magneto-optic disc (MD) drive or the like.

The communication device 103 is a communication module that communicates with an external device via a communication network. The communication device 103 may perform wireless communication using a mobile phone line or a satellite channel. The mobile terminal device 100 may communicate with the meter 50 by use of the communication device 103. The communication device 103 may perform wired communication and/or wireless communication. The communication device 103 may perform wired communication compliant to a communication protocol such as, for example, USB, IEEE1394 (registered trademark), Ethernet (registered trademark) or the like. The communication device 103 may perform wireless communication compliant to, for example, the Bluetooth (registered trademark) protocols and/or the Wi-Fi (registered trademark) protocols. Either protocol includes a wireless communication protocol using a frequency of the 2.4 GHz band or the 5.0 GHz band. The communication device 103 may be a communication module capable of performing wireless communication compliant to the BLE communication system or the LPWA communication system.

The input device 104 converts an instruction from the user into data and inputs the data to a computer. The input device 104 may be, for example, a touch panel. The mobile terminal device 100 may include, as the input device 104, a push-button switch and/or a microphone. The display 105 includes, for example, a liquid crystal panel, an OLED panel or an electronic paper panel.

The speaker 106 converts an audio signal into a sound and outputs the sound to the outside. The microphone 107 converts a sound around the mobile terminal device 100 into an audio signal. The speaker 106 and the microphone 107 may be used as a voice call device that performs a voice call with another user. The camera 108 captures a portion of an area around the mobile terminal device 100 and generates an image signal. The lamp 109 emits light. The processor 111 may control the operations of the display 105, the speaker 106, the lamp 109 or the like to notify the user of information.

The positioning device 110 may detect the position of the mobile terminal device 100 in a geographical coordinate system (geographical coordinates of the mobile terminal device 100). The positioning device 110 receives a GNSS signal sent from a GNSS satellite and performs positioning based on the GNSS signal. “GNSS” is a collective term of satellite positioning systems including GPS (Global Positioning System), QZSS (Quasi-Zenith Satellite System; for example, Michibiki), GLONASS, Galileo, BeiDou and the like. The positioning method may be any method by which positional information of a necessary level of precision is obtained. The positioning method may be, for example, an interference positioning method or a relative positioning method. The user rides on the electrically assisted bicycle 1 while carrying the mobile terminal device 100, so that the position of the electrically assisted bicycle 1 may be detected.

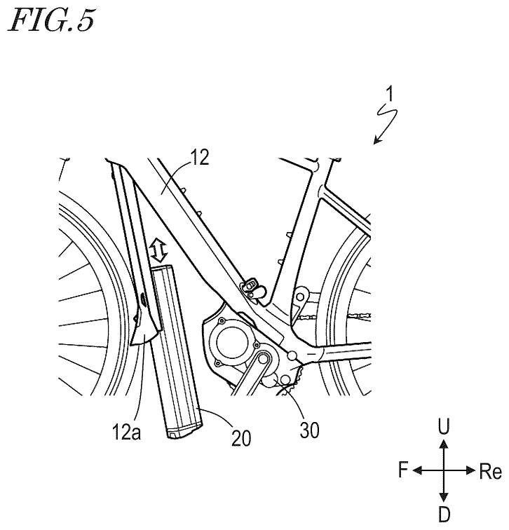

As described above, the battery unit 20 may be a portable battery unit that is detachable from the electrically assisted bicycle 1. FIG. 5 shows how the battery unit 20 is attached to, and detached from, the electrically assisted bicycle 1. In this example, the battery unit 20 is provided inside the down tube 12. At least a portion of the down tube 12 has a U-shaped cross-section, and the down tube 12 is provided with a cover 12a covering the U-shaped portion. The cover 12a is opened, so that the battery unit 20 may be detached from, or attached to, the down tube 12.

The battery unit 20 may be charged by being connected with an external charging device in a state of being detached from the electrically assisted bicycle 1. Even in the case where, for example, the charging device that charges the battery unit 20 is not provided at a parking spot, the battery unit 20 may be carried to the spot where the charging device is located and then charged.

The battery unit 20 does not need to be detachable from the electrically assisted bicycle 1, and may be secured to the bicycle 1 and undetachable. In this case, the bicycle 1 and the charging device may be connected with each other to charge the battery unit 20. Even in the case where the battery unit 20 is detachable from the bicycle 1, the bicycle 1 and the charging device may be connected with each other in a state where the battery unit 20 is attached to the bicycle 1, so that the battery unit 20 is charged.

Now, the notification system 10 that notifies the user of information about the battery unit 20 of the electrically assisted bicycle 1 will be described.

The mobile terminal device 100 is an example of the notification system 10. For example, application software that causes the mobile terminal device 100 to operate as the notification system 10 is installed on the mobile terminal device 100, so that the mobile terminal device 100 operates as the notification system 10. The application software may be, for example, downloaded from an external device such as a server or the like via a communication network and installed on the mobile terminal device 100. Such application software may be marketed as commercial software. The application software is, for example, stored on the storage 102 or the ROM 112, and the processor 111 executes an operation of notifying the user of information in accordance with the application software. For example, the processor 111 issues a notification urging the user to charge the battery unit 20.

In this example embodiment, when the battery remaining capacity is decreased to a small value, the notification urging the user to charge the battery unit 20 is issued at the timing when the electrically assisted bicycle 1 gets close to a battery charging point (predetermined point), where the battery unit 20 is chargeable.

The battery charging point, where the battery unit 20 is chargeable, may be set in advance by, for example, the user operating the mobile terminal device 100 or the like. The processor 111 may operate in accordance with the application software to accept the operation, made by the user, of setting the battery charging point.

The battery charging point is, for example, a point where a charging device that charges the battery unit 20 is located. The battery charging point may be, for example, the user's house. The battery charging point may be, for example, the school, the workplace or the like to which the user belongs. The battery charging point may be a point where the battery unit 20 is to be detached from the bicycle 1 in a parked state in order to be charged. In, for example, an apartment complex or the like, the bicycle parking area and the user's house where the charging device is located may be far from each other. In such a case, the bicycle parking area may be set as the battery charging point.

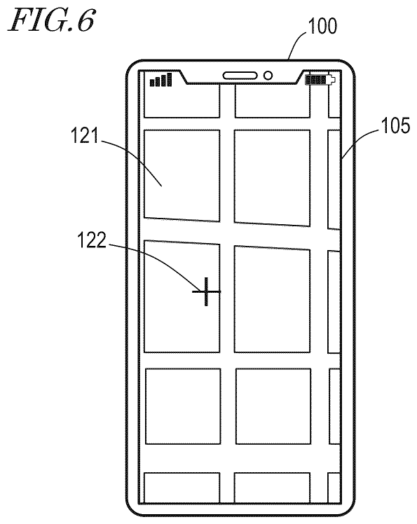

FIG. 6 shows an example of setting the battery charging point. The processor 111 causes the display 105 to display a map 121. Map information may be stored on the storage 102 or may be obtained from an external device such as a server or the like via a communication network. For example, the mobile terminal device 100 includes a touch panel as the input device 55, and the user operates the touch panel with his/her finger such that the position on the map that the user wants to set as the battery charging point matches the position of a pointer 122. The battery charging point may be set in this manner. Map information includes information on geographical coordinates of each of positions on the map. The processor 111 reads, from the map information, geographical coordinates of the battery charging point that is set by the user.

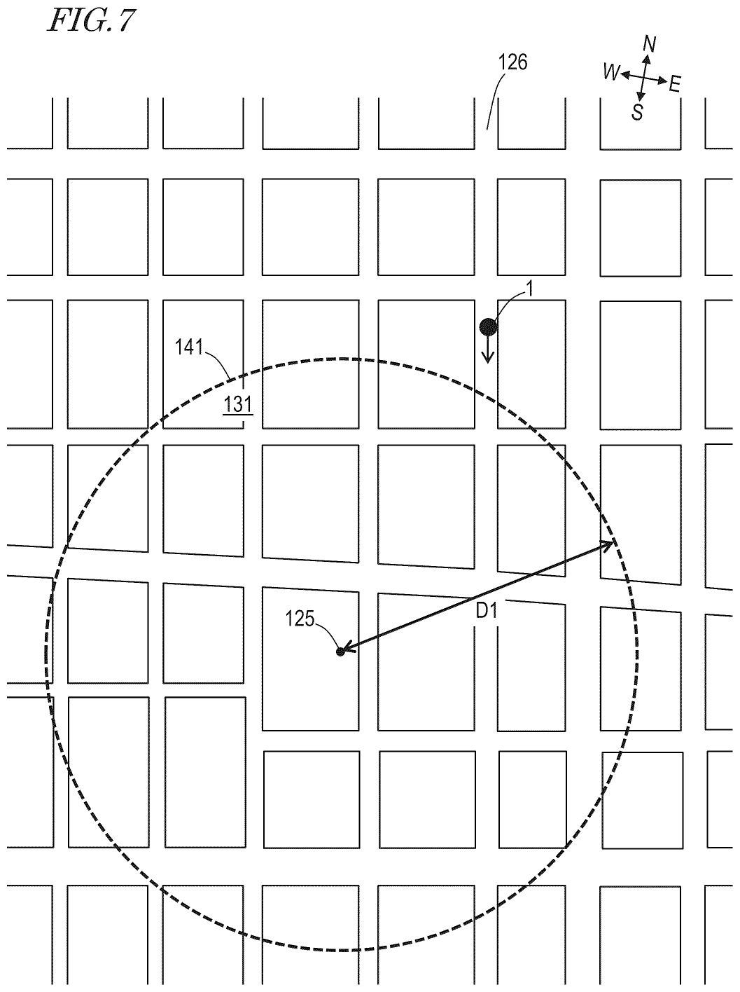

Next, the processor 111 sets a first border between a first area encompassing the battery charging point and an area outward of the first area. FIG. 7 shows an example of the first border.

At least a portion of a first border 141 is set to be spaced away by a first distance D1 from the battery charging point (represented with reference sign 125). The first distance D1 is, for example, about 50 meters or longer and about 200 meters or shorter, but is not limited to a value in such a range. In this example, the first distance D1 is 100 meters.

For example, the processor 111 reads, from the map information, geographical coordinates of each of positions that are spaced away by the first distance D1 from the position represented by the geographical coordinates of the battery charging point 125, and thus may set the first border 141 at a position that is spaced away from the battery charging point 125 by the first distance D1.

In the example shown in FIG. 7, the first border 141 enclosing the battery charging point 125 defines a circle centered around the battery charging point 125 on the map. The first border 141 may have any shape, and is not limited to having a circular shape. For example, the user may move his/her finger on the map to set the first border 141.

An area inward of the first border 141 is set as a first area 131. The first border 141 is the border between the first area 131 and the area outward of the first area 131.

The processor 111 stores first border information representing contents of the first border 141 in the storage 102.

As described above, the mobile terminal device 100 and the meter 50 are wirelessly communicable to each other. The mobile terminal device 100 and the meter 50 perform wireless communication compliant to, for example, the Bluetooth (registered trademark) protocol. The mobile terminal device 100 is housed in, for example, a pocket of the user's outfit or a bag of the user. The mobile terminal device 100 may be attached to the handle 4 or the like of the electrically assisted bicycle 1.

As described above, the BMS 21 (FIG. 3) of the battery unit 20 sends the battery information representing the voltage, the current, the temperature, the SOC or the like of the battery unit 20 to the MCU 31 of the drive unit 30. The MCU 31 outputs the SOC information representing the SOC of the battery unit 20 to the meter 50. The processor 61 of the meter 50 calculates the battery remaining capacity based on the SOC information on a regular basis. In this example embodiment, the battery remaining capacity is represented with a state where the battery unit 20 is fully charged being 100% and a state where the battery unit 20 is fully discharged being 0%. In the case where a value of the SOC is used as the value of the battery remaining capacity, the value of the SOC and the value of the battery remaining capacity are equal to each other. The processor 61 causes the display 51 to display the current battery remaining capacity, and sends battery remaining capacity information that represents the battery remaining capacity to the mobile terminal device 100 on a regular basis.

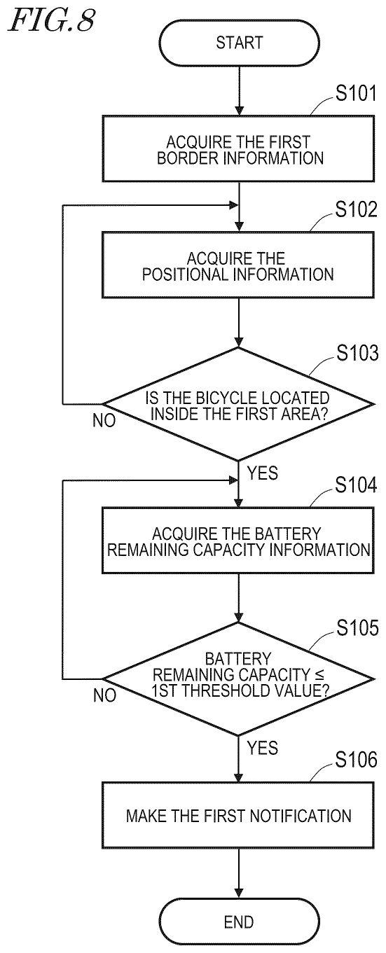

Now, an operation of issuing a notification urging the user to charge the battery unit 20 when the battery remaining capacity is decreased to a small value will be described. FIG. 8 is a flowchart showing an example of an operation of issuing a first notification urging the user to charge the battery unit 20.

The processor 111 of the mobile terminal device 100 acquires first border information representing the contents of the first border 141 (step S101). For example, the processor 111 reads the first border information from the storage 102.

The positioning device 110 of the mobile terminal device 100 detects the geographical coordinates of the mobile terminal device 100. The geographical coordinates of the mobile terminal device 100 carried by the user riding on the electrically assisted bicycle 1 correspond to geographical coordinates of the bicycle 1. The processor 111 acquires the geographical coordinates detected by the positioning device 110 as positional information representing the current position of the bicycle 1 (step S102).

The processor 111 determines whether or not the bicycle 1 is located inside the first area 131 based on the first border information and the positional information (step S103). For example, the processor 111 compares geographical coordinates representing the first border 141 and the geographical coordinates representing the current position of the bicycle 1 against each other, and thus may determine whether or not the bicycle 1 is located inside the first area 131.

FIG. 7 shows the electrically assisted bicycle 1 traveling on a road 126 toward the battery charging point 125. In the example shown in FIG. 7, the bicycle 1 is located in the area outward of the first area 131. In this case, the processor 111 determines that the bicycle 1 is not located inside the first area 131, and returns to the process in step S102.

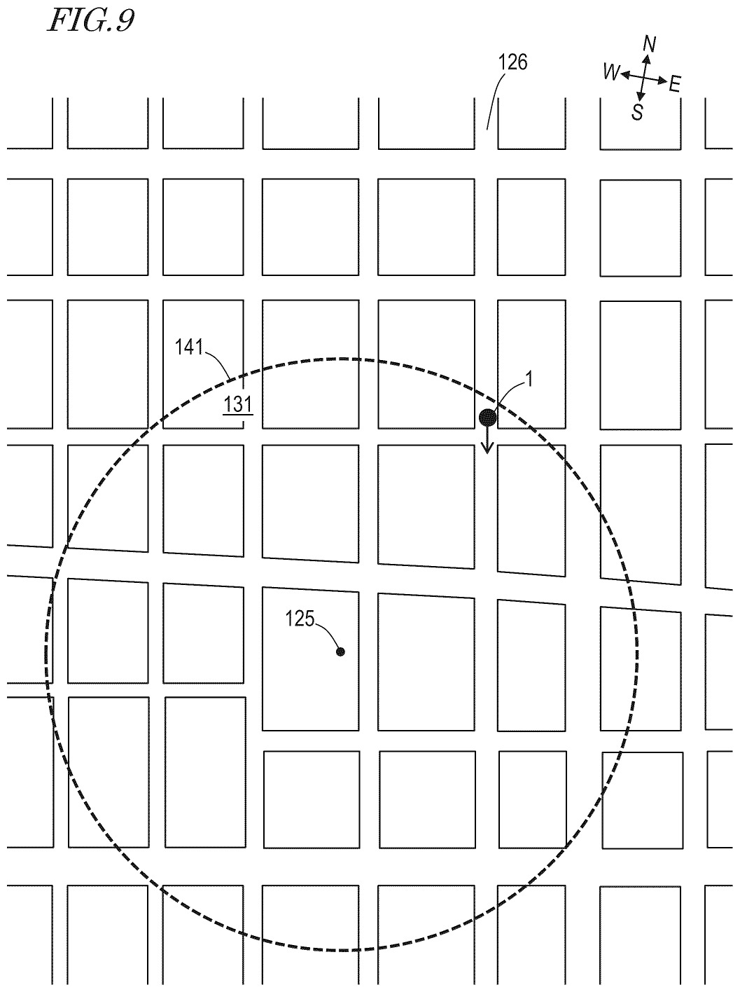

FIG. 9 shows a state where the electrically assisted bicycle 1 that has been traveling on the road 126 toward the battery charging point 125 is now inside the first area 131. In this case, the processor 111 determines that the bicycle 1 is located inside the first area 131.

In the case it is determined that the electrically assisted bicycle 1 is located inside the first area 131, the processor 111 acquires the battery remaining capacity information (step S104). The processor 111 determines whether or not the battery remaining capacity is not larger than a first threshold value (step S105). The first threshold value is set to a value in the range of, for example, about 20% or higher and about 60% or lower, but is not limited to a value in such a range. In this example, the first threshold value is set to 30%.

In the case it is determined that the battery remaining capacity is larger than the first threshold value, the processor 111 does not issue the first notification urging the user to charge the battery unit 20, and returns to the process in step S104. In the case it is determined that the battery remaining capacity is larger than the first threshold value, the processor 111 may return to the process in step S102.

In the case it is determined that the battery remaining capacity is not larger than the first threshold value, the processor 111 issues the first notification via a notifier (step S106) urging the user to charge the battery unit 20.

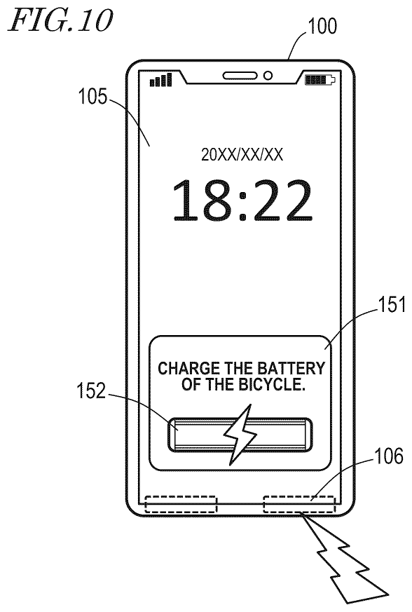

FIG. 10 shows an example of mobile terminal device 100 issuing the first notification to the user. The notifier includes, for example, the display 105 and the speaker 106. The speaker 106 is an example of a sound production component.

The processor 111 causes the display 105 to display at least one of a letter(s) or a graphical pattern that urges the user to charge the battery unit 20. In the example shown in FIG. 10, a popup window 151 is displayed on the display 105, and the letters “Charge the battery of the bicycle” and an illustration 152 of a battery urging the user to charge the battery are displayed in the popup window 151. The user looks at display contents of the display 105 and thus may keep in mind that he/she has to charge the battery unit 20 when arriving at the battery charging point 125.

The processor 111 causes the speaker 106 to output a voice that urges the user to charge the battery unit 20. For example, the voice “Charge the battery of the bicycle” is output from the speaker 106. The user hears the voice output by the speaker 106 and thus may keep in mind that he/she has to charge the battery unit 20 when arriving at the battery charging point 125.

In the case where the mobile terminal device 100 is attached to the handle 4 or the like of the bicycle 1, the above-described notification allows the user to more easily recognize that he/she has to charge the battery unit 20.

In this example embodiment, in the case where the battery remaining capacity is not larger than the first threshold value, the first notification urging the user to charge the battery unit 20 may be issued at the timing when the bicycle 1 gets close to the battery charging point 125, where the battery unit 20 is chargeable. This allows the user to keep in mind that he/she has to charge the battery unit 20 when arriving at the battery charging point 125.

If the first notification is issued when the bicycle 1 arrives at the battery charging point 125, the following may occur. If the actual position of the bicycle 1 is deviated from the position represented by the positional information, the first notification may not be issued even though the bicycle 1 arrives at the battery charging point 125. According to this example embodiment, the first notification is issued while the bicycle 1 is located inside the first area 131, which has a large area. Therefore, even if the actual position of the bicycle 1 is deviated from the position represented by the positional information, the first notification may be issued.

The first notification is issued in the case where the battery remaining capacity is not larger than the first threshold value so that the uneasiness that the user feels regarding the possibility that the battery remaining capacity becomes zero without him/her noticing may be alleviated.

In this example embodiment, the first border 141 is set to a position that is spaced away from the battery charging point 125 by the first distance D1. This allows the first notification to be issued before the bicycle 1 arrives at the battery charging point 125 (e.g., several tens of seconds before the bicycle 1 arrives at the battery charging point 125). Therefore, the user may keep in mind that he/she has to charge the battery unit 20 when arriving at the battery charging point 125.

In the examples shown in FIG. 7 and FIG. 9, the first border 141 enclosing the battery charging point 125 defines a circle centered around the battery charging point 125 on the map. In the case where the shape of the first border 141 is a perfect circle centered around the battery charging point 125, the first notification may be issued at a common timing regardless of the direction in which the bicycle 1 approaches the battery charging point 125.

In this example embodiment, the mobile terminal device 100 issues the first notification, and therefore, there is no need to mount a notifier on the bicycle 1. This allows the bicycle 1 to have a simple configuration. The mobile terminal device 100 executes a process of determining whether or not to issue the first notification, and therefore, there is no need to mount a device executing such a process on the bicycle 1. This also allows the bicycle 1 to have a simple configuration.

In the example shown in FIG. 8, the processes in step S104 and step S105 are performed after the processes in step S102 and step S103. The order of the processes is not limited to this. For example, the processes in step S102 and step S103 may be performed after the processes in step S104 and S105. Alternatively, the processes in step S103 and step S105 may be performed after the processes in step S102 and S104.

Now, an operation of issuing the first notification when the bicycle 1 traveling toward the first area 131 from the area outward of the first area 131 passes the position of the first border 141.

Regarding step S103, the “process of determining whether or not the bicycle 1 is located inside the first area 131” may include a “process of determining whether or not the bicycle 1 has passed the position of the first border 141 into the first area 131 from the area outward of the first area 131”.

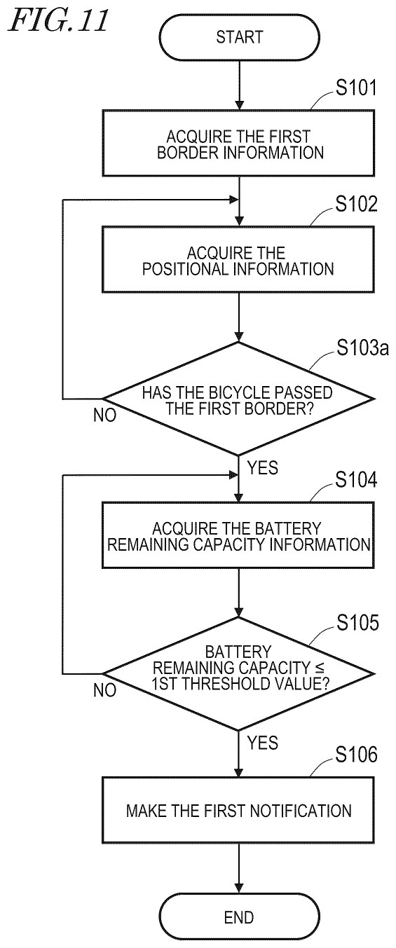

FIG. 11 is a flowchart showing an example of an operation of issuing the first notification urging the user to charge the battery unit 20. In the processes shown in FIG. 11, instead of the process in step S103 shown in FIG. 8, the processor 111 determines whether or not the bicycle 1 has passed the position of the first border 141 into the first area 131 from the area outward of the first area 131 (step 103a). For example, the processor 111 compares the geographical coordinates representing the first border 141 and the geographical coordinates representing the current position of the bicycle 1 against each other, and thus may determine whether or not the bicycle 1 has passed the position of the first border 141 into the first area 131 from the area outward of the first area 131.

As described above, FIG. 7 shows the electrically assisted bicycle 1 traveling on the road 126 toward the battery charging point 125. In the example shown in FIG. 7, the bicycle 1 is located in the area outward of the first area 131. FIG. 9 shows a state where the bicycle 1 that has been traveling on the road 126 toward the battery charging point 125 from the state shown in FIG. 7 is now inside the first area 131. That is, FIG. 9 shows that the bicycle 1 has passed the position of the first border 141 into the first area 131 from the area outward of the first area 131. In this case, the processor 111 determines that the bicycle 1 has passed the position of the first border 141 into the first area 131 from the area outward of the first area 131.

In the case it is determined that the bicycle 1 has passed the position of the first border 141 into the first area 131 from the area outward of the first area 131, the processor 111 acquires the battery remaining capacity information (step S104), and determines whether or not the battery remaining capacity is not larger than the first threshold value (step S105).

In the case it is determined that the battery remaining capacity is larger than the first threshold value, the processor 111 dose not issue the first notification urging the user to charge the battery unit 20, and returns to the process in step S104. In the case it is determined that the battery remaining capacity is larger than the first threshold value, the processor 111 may return to the process in step S102.

In the case it is determined that the battery remaining capacity is not larger than the first threshold value, the processor 111 issues the first notification via the notifier (step S106) urging the user to charge the battery unit 20.

In the case where the processor 111 does not issue the first notification when the bicycle 1 passes the position of the first border 141 but after that, the battery remaining capacity is decreased to a value not larger than the first threshold value while the bicycle 1 is located inside the first area 131, the processor 111 may issue the first notification. In this manner, even in the case where the processor 111 does not issue the first notification when the bicycle 1 passes the position of the first border 141, if, after that, the battery remaining capacity is decreased to a value not larger than the first threshold value, the processor 111 may issue the first notification at a position close to the battery charging point 125.

In the example shown in FIG. 11, the processes in step S104 and step S105 are performed after the processes in step S102 and step S103a. The order of the processes is not limited to this. For example, the processes in step S102 and step S103a may be performed after the processes in step S104 and S105. Alternatively, the processes in step S103a and step S105 may be performed after the processes in step S102 and S104.

In the above-described example embodiments, the mobile terminal device 100 operates as the notification system 10. Alternatively, the meter 50 may operate as the notification system 10. In this case, the various processes shown in FIG. 8 and FIG. 11 may be executed by the processor 61. Alternatively, the various processes shown in FIG. 8 and FIG. 11 may be executed by the processor 111 whereas the first notification may be issued by the meter 50. The mobile terminal device 100 and the meter 50 may cooperate with each other to operate as the notification system 10.

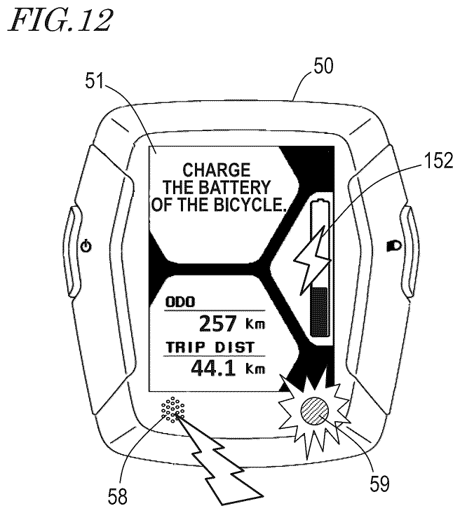

FIG. 12 shows an example of the meter 50 issuing the first notification to the user. The notifier includes, for example, the display 51 and the speaker 58.

The processor 61 causes the display 51 to display at least one of a letter(s) or a graphical pattern that urges the user to charge the battery unit 20. In the example shown in FIG. 12, the letters “Charge the battery of the bicycle” and an illustration 152 urging the user to charge the battery are displayed on the display 51. The user looks at the display contents of the display 51 and thus may keep in mind that he/she has to charge the battery unit 20 when arriving at the battery charging point 125.

The processor 61 causes the speaker 58 to output a voice that urges the user to charge the battery unit 20. For example, the voice “Charge the battery of the bicycle” is output from the speaker 58. The user hears the voice output by the speaker 106 and thus may keep in mind that he/she has to charge the battery unit 20 when arriving at the battery charging point 125.

The processor 61 may cause the lamp 59 to blink to attract the user's attention. This allows the user to notice the first notification easily.

Now, an operation of, in the case where the electrically assisted bicycle 1 gets far from the battery charging point 125, issuing a notification urging the user to move the bicycle 1 to the battery charging point 125 will be described.

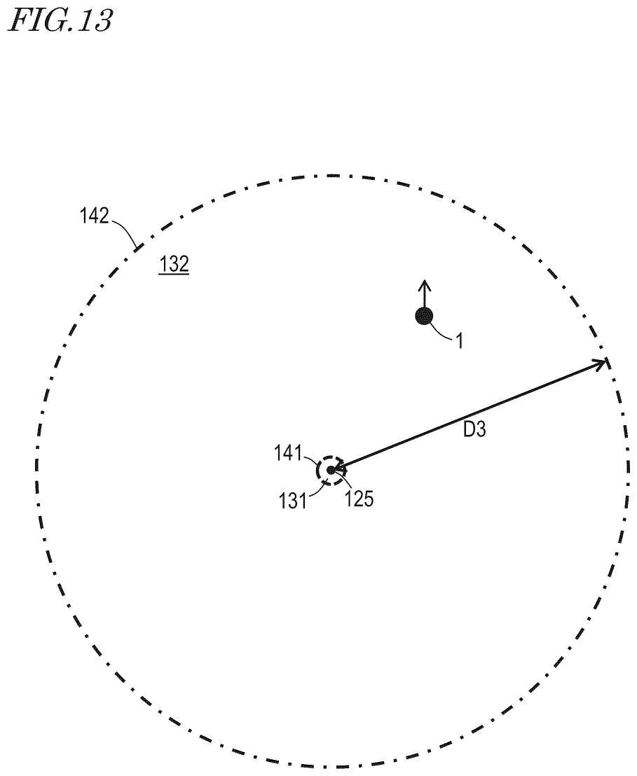

FIG. 13 shows an example of second area 132 enclosing the first area 131 and an example of second border 142 located along an outer perimeter of the second area 132.

In the case where the bicycle 1 gets far from the battery charging point 125, the battery remaining capacity may undesirably become zero before the bicycle 1 arrives back at the battery charging point 125. In this example embodiment, in the case where the bicycle 1 has passed the position of the second border 142 into an area outward of the second area 132 from the second area (predetermined area) 132, a notification urging the user to move the bicycle 1 to the battery charging point 125 is issued.

Based on the battery remaining capacity of the battery unit 20, the processor 111 calculates a second distance D2, by which the bicycle 1 is able to travel with the output current from the battery unit 20 (calculates a distance-to-empty D2). For example, the application software includes information on a table representing the relationship between the battery remaining capacity and the distance-to-empty, and the processor 111 may use the information to calculate the second distance D2. Such a table may be prepared for each of models of the bicycle 1 and/or each of model numbers of the battery. Information on such a table may be acquired from an external device such as a server or the like via a communication network.

The processor 111 sets the position of the second border 142 such that a distance D3 between the battery charging point 125 and the second border 142 is shorter than the second distance D2. This may decrease the possibility that the battery remaining capacity becomes zero before the electrically assisted bicycle 1 arrives back at the battery charging point 125.

For example, the processor 111 sets the position of the second border 142 such that the third distance D3 is at least about 0.3 times and at most about 0.7 times the second distance D2. The relationship in length between the second distance D2 and the third distance D3 is not limited to this. In this example, the third distance D3 is 0.5 times the second distance D2.

For example, the processor 111 reads, from the map information, geographical coordinates of each of positions that are spaced away by the third distance D3 from the position represented by the geographical coordinates of the battery charging point 125, and thus may set the second border 142 at the position that is spaced away from the battery charging point 125 by the third distance D3. The second border 142 is the border between the second area 132 and the area outward of the second area 132. The processor 111 stores second border information representing contents of the second border 142 in the storage 102.

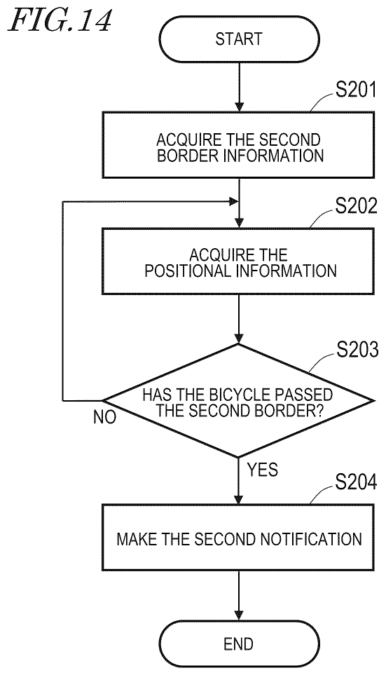

FIG. 14 is a flowchart showing an example of an operation of issuing a second notification urging the user to move the electrically assisted bicycle 1 to the battery charging point 125.

The processor 111 acquires the second border information representing the contents of the second border 142 (step S201). For example, the processor 111 reads the second border information from the storage 102. The processor 111 acquires the geographical coordinates detected by the positioning device 110 as positional information that represents the current position of the bicycle 1 (step S202).

Based on the second border information and the positional information, the processor 111 determines whether or not the bicycle 1 has passed the position of the second border 142 into the area outward of the second area 132 from the second area 132 (step S203). For example, the processor 111 compares geographical coordinates representing the second border 142 and the geographical coordinates representing the current position of the bicycle 1 against each other, and thus may determine whether or not the bicycle 1 has passed the position of the second border 142 into the area outward of the second area 132 from the second area 132.

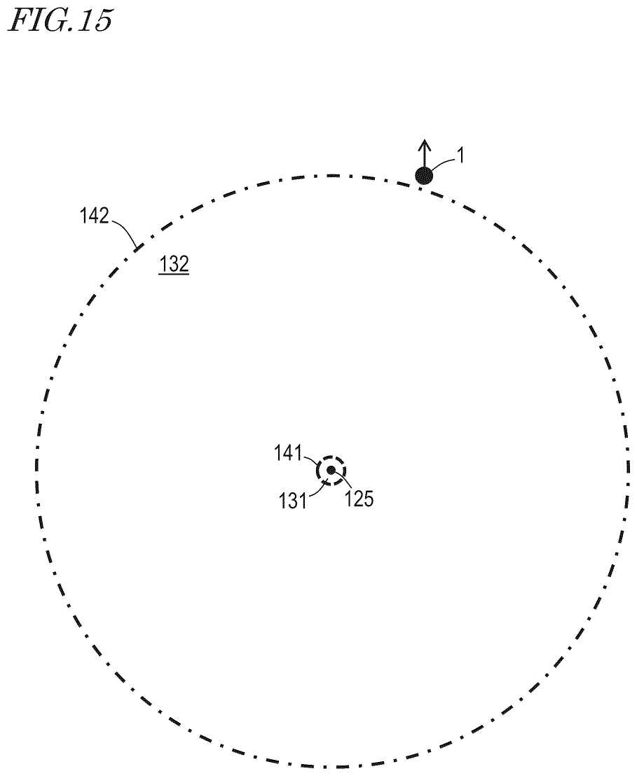

FIG. 13 shows the bicycle 1 traveling inside the second area 132. FIG. 15 shows a state where the bicycle 1 that has been moving from the state shown in FIG. 13 is now located in the area outward of the second area 132. That is, FIG. 15 shows that the bicycle 1 has passed the position of the second border 142 into the area outward of the second area 132 from the second area 132. In this case, the processor 111 determines that the bicycle 1 has passed the position of the second border 142 into the area outward of the second area 132 from the second area 132.

In the case it is determined that the bicycle 1 has passed the position of the second border 142 into the area outward of the second area 132 from the second area 132, the processor 111 issues the second notification via the notifier (step S204) urging the user to move the bicycle 1 to the battery charging point 125.

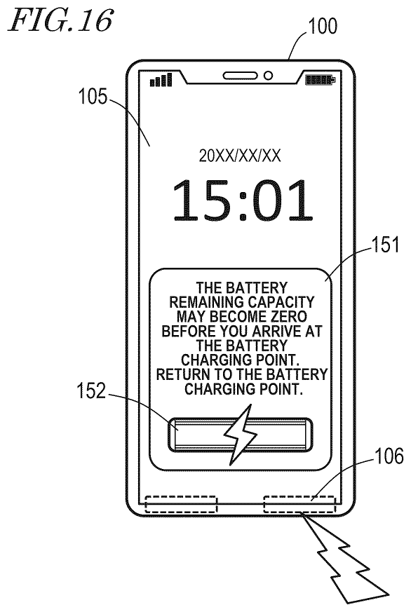

FIG. 16 shows an example of the mobile terminal device 100 issuing the second notification to the user. The notifier includes, for example, the display 105 and the speaker 106.

The processor 111 causes the display 105 to display at least one of a letter(s) or a graphical pattern that urges the user to move the bicycle 1 to the battery charging point 125. In the example shown in FIG. 16, the popup window 151 is displayed on the display 105, and the letters “The battery remaining capacity may become zero before you arrive back at the battery charging point. Return to the battery charging point.” and the illustration 152 of a battery urging the user to charge the battery are displayed in the popup window 151. The user looks at the display contents of the display 105 and thus may recognize that if the electrically assisted bicycle 1 is farther away from the battery charging point 125, the battery remaining capacity may possibly become zero before the bicycle 1 arrives back at the battery charging point 125.

The processor 111 causes the speaker 106 to output a voice that urges the user to move the bicycle 1 to the battery charging point 125. For example, the voice “The battery remaining capacity may become zero before you arrive back at the battery charging point. Return to the battery charging point.” is output from the speaker 106. The user hears the voice output by the speaker 106 and thus may recognize that if the electrically assisted bicycle 1 is farther away from the battery charging point 125, the battery remaining capacity may possibly become zero before the bicycle 1 arrives back at the battery charging point 125.

In the case where the mobile terminal device 100 is attached to the handle 4 or the like of the bicycle 1, the user may recognize contents of the second notification more easily. In the case where the bicycle 1 gets far from the battery charging point 125, the battery remaining capacity may undesirably become zero before the bicycle 1 arrives back at the battery charging point 125. In the case where the bicycle 1 has passed the position of the second border 142 into the area outward of the second area 132, the notification urging the user to move the bicycle 1 to the battery charging point 125 is issued. This allows the user to recognize that if the electrically assisted bicycle 1 is farther away from the battery charging point 125, the battery remaining capacity may possibly become zero before the bicycle 1 arrives back at the battery charging point 125.

The processor 111 may change the position of the second border 142 in accordance with a change in the battery remaining capacity. This allows the position of the second border 142 to be updated to the position suitable to the current battery remaining capacity. For example, the length of the second distance D2 and the length of the third distance D3 may be changed in accordance with the change in the battery remaining capacity to update the position of the second border 142. Alternatively, for example, the processor 111 may calculate the second distance D2 and the third distance D3 on a regular basis to update the position of the second border 142.

In the above-described example embodiments, the mobile terminal device 100 operates as the notification system 10. Alternatively, the meter 50 may operate as the notification system 10. In this case, the various processes shown in FIG. 14 may be executed by the processor 61. Alternatively, the various processes shown in FIG. 14 may be executed by the processor 111 whereas the second notification may be issued by the meter 50. The mobile terminal device 100 and the meter 50 may cooperate with each other to operate as the notification system 10.

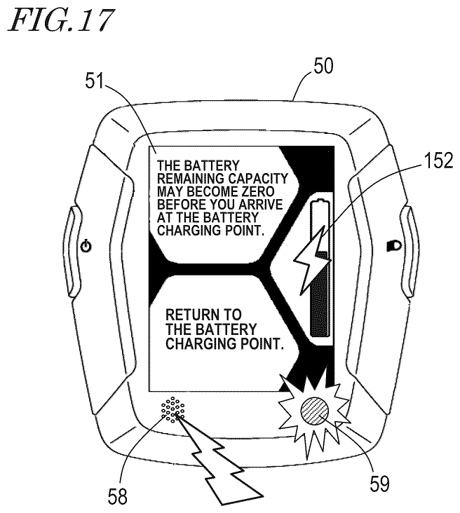

FIG. 17 shows an example of the meter 50 issuing the second notification to the user. The notifier includes, for example, the display 51 and the speaker 58.

The processor 61 causes the display 51 to display at least one of a letter(s) or a graphical pattern that urges the user to move the bicycle 1 to the battery charging point 125. In the example shown in FIG. 17, the letters “The battery remaining capacity may become zero before you arrive back at the battery charging point. Return to the battery charging point.” and the illustration 152 urging the user to charge the battery are displayed on the display 51. The user looks at the display contents of the display 51 and thus may recognize that if the electrically assisted bicycle 1 is farther away from the battery charging point 125, the battery remaining capacity may possibly become zero before the bicycle 1 arrives back at the battery charging point 125.

The processor 61 causes the speaker 58 to output a voice that urges the user to move the bicycle 1 to the battery charging point 125. For example, the voice “The battery remaining capacity may become zero before you arrive back at the battery charging point. Return to the battery charging point.” is output from the speaker 58. The user hears the voice output by the speaker 58 and thus may recognize that if the electrically assisted bicycle 1 is farther away from the battery charging point 125, the battery remaining capacity may possibly become zero before the bicycle 1 arrives back at the battery charging point 125.

The processor 61 may cause the lamp 59 to blink to attract the user's attention. This allows the user to notice the second notification easily.

In the above-described example embodiments, a two-wheeled vehicle is shown as an example of the electric vehicle. The present invention is not limited to this. The electric vehicle may be, for example, a three-wheeled electrically assisted vehicle.

In the above-described example embodiments, the driving wheel to which the power of a human body generated by the user stepping on the pedals and the assist power generated by the electric motor are to be conveyed is the rear wheel. The present invention is not limited to this. The power of the human body and the assist power may be conveyed to the front wheel, or may be conveyed to both of the front wheel and the rear wheel, in accordance with the form of the electrically assisted bicycle. The present invention may be applied to an electrically assisted bicycle including a hub motor on the front wheel.

The battery charging point 125 may be a charge spot provided in a city center or the like.

Illustrative example embodiments of the present invention are described above. Example embodiments disclose notification systems, notification methods and non-transitory computer readable media including computer programs as below.

A notification system 10 for issuing a notification urging a user to charge a battery 20 of an electric vehicle 1 includes a processor 111; and a storage 102, 112 to store a computer program to control an operation of the processor 111, wherein, the processor 111 is configured or programmed to execute the computer program to acquire first border information representing a first border 141 between a first area 131, encompassing a predetermined point 125 where the battery 20 is chargeable, and an area outward of the first area 131; acquire positional information representing a current position of the electric vehicle 1 and battery remaining capacity information representing a battery remaining capacity of the battery 20; and in a case it is determined that the electric vehicle 1 is located inside the first area 131 and that the battery remaining capacity of the battery 20 is not larger than a first threshold value based on the first border information, the positional information, and the battery remaining capacity information, issue a first notification via a notifier 105, 106 urging the user to charge the battery 20.

In the case where the battery remaining capacity is not larger than the first threshold value, the first notification urging the user to charge the battery 20 may be issued at the timing when the electric vehicle 1 gets close to the predetermined point 125, where the battery 20 is chargeable. This allows the user to keep in mind that he/she has to charge the battery 20 when arriving at the predetermined point 125.

If the first notification is issued when the electric vehicle 1 arrives at the predetermined point 125, the following may occur. If the actual position of the electric vehicle 1 is deviated from the position represented by the positional information, the first notification may not be made even though the electric vehicle 1 arrives at the predetermined point 125. According to an example embodiment of the present invention, the first notification is issued while the electric vehicle 1 is located inside the first area 131, which has a large area. Therefore, even if the actual position of the electric vehicle 1 is deviated from the position represented by the positional information, the first notification may be issued.

The first notification is issued in the case where the battery remaining capacity is not larger than the first threshold value so that the uneasiness that the user feels regarding the possibility that the battery remaining capacity becomes zero without him/her noticing may be alleviated.

In the notification system 10, in a case it is determined that the electric vehicle 1 has passed a position of the first border 141 into the first area 131 from the area outward of the first area 131 and that the battery remaining capacity of the battery 20 is not larger than the first threshold value, the processor 111 issues the first notification.

With this arrangement, the first notification may be issued at the timing when the electric vehicle 1 gets close to the predetermined point 125. This allows the user to keep in mind that he/she has to charge the battery 20 when arriving at the predetermined point 125.

The first notification is issued when the electric vehicle 1 passes the first border 141, which is spaced away from the predetermined point 125 by a certain distance. Therefore, even if the actual position of the electric vehicle 1 is deviated from the position represented by the positional information, the first notification may be issued.

In the notification system 10, in the case it is determined that the electric vehicle 1 has passed the position of the first border 141 into the first area 131 from the area outward of the first area 131 and that the battery remaining capacity of the battery 20 is larger than the first threshold value, the processor 111 does not issue the first notification.

With this arrangement, the notification may be not issued in the case where there is no need to charge the battery 20 in a hurry.

In the notification system 10, in the case where the processor 111 does not make the first notification when the electric vehicle 1 passes the position of the first border 141 but later determines that the battery remaining capacity of the battery 20 is decreased to a value not larger than the first threshold value while the electric vehicle 1 is located inside the first area 131, the processor 111 issues the first notification.

With this arrangement, even in the case where the first notification is not issued when the electric vehicle 1 passes the position of the first border 141, if, after that, the battery remaining capacity is decreased to a value not larger than the first threshold value, the first notification may be issued at a position close to the predetermined point 125.

In the notification system 10, at least a portion of the first border 141 is spaced away from the predetermined point 125 by a first distance D1.

With this arrangement, the first notification may be issued before the electric vehicle 1 arrives at the predetermined point 125. This allows the user to keep in mind that he/she has to charge the battery 20 when arriving at the predetermined point 125.

In the notification system 10, the first distance D1 is about 50 meters or longer and about 200 meters or shorter.

With this arrangement, the first notification may be issued before (e.g., several tens of seconds before) the electric vehicle 1 arrives at the predetermined point 125.

In the notification system 10, the first border 141 defines a circle centered around the predetermined point 125 on a map.

With this arrangement, the first notification may be issued at a common timing regardless of the direction in which the electric vehicle 1 approaches the predetermined point 125.

In the notification system 10, the battery remaining capacity of the battery 20 is represented by SOC (State of Charge), and the first threshold value is set to an SOC value of about 20% or higher and about 60% or lower.

With this arrangement, the first notification may be issued at a timing when it is recommended to charge the battery 20.

In the notification system 10, the processor 111 is configured or programmed to acquire second border information representing a second border 142 located along an outer perimeter of a second area 132 enclosing the first area 131, and in a case it is determined that the electric vehicle 1 has passed a position of the second border 142 into an area outward of the second area 132 from the second area 132, issue a second notification via the notifier 105 urging the user to move the electric vehicle 1 to the predetermined point 125, 106.

In the case where the electric vehicle 1 gets far from the predetermined point 125 where the battery 20 is chargeable, the battery remaining capacity may undesirably become zero before the electric vehicle 1 arrives back at the predetermined point 125. In the case where the electric vehicle 1 has passed the position of the second border 142 into the area outward of the second area 132, a notification urging the user to move the electric vehicle 1 to the predetermined point 125 is issued. This allows the user to recognize that if the electric vehicle 1 is farther away from the predetermined point 125, the battery remaining capacity may possibly become zero before the electric vehicle 1 arrives back at the predetermined point 125.

In the notification system 10, the processor 111 is configured or programmed to calculate, based on the battery remaining capacity of the battery 20, a second distance D2, by which the electric vehicle 1 is able to travel with an output current from the battery 20, and set the position of the second border 142 such that a third distance D3 between the predetermined point 125 and the second border 142 is shorter than the second distance D2.

With this arrangement, the possibility that the battery remaining capacity becomes zero before the electric vehicle 1 arrives back at the predetermined point 125 may be decreased.

In the notification system 10, the processor 111 is configured or programmed to change the position of the second border 142 in accordance with a change in the battery remaining capacity of the battery 20.

With this arrangement, the second border 142 may be set at the position suitable to the current battery remaining capacity of the battery 20.

In the notification system 10, the processor 111 is configured or programmed to set the position of the second border 142 such that the third distance D3 is at least about 0.3 times and at most about 0.7 times the second distance D2.

With this arrangement, the possibility that the battery remaining capacity becomes zero before the electric vehicle 1 arrives back at the predetermined point 125 may be decreased.

In the notification system 10, the notifier 105, 106 is included in a mobile terminal device 100, and the electric vehicle 1 and the mobile terminal device 100 communicate information with each other by wireless communication.

With this arrangement, the first notification urging the user to charge the battery 20 may be issued by the mobile terminal device 100. This makes it unnecessary to mount the notifier 105, 106 on the electric vehicle 1.

In the notification system 10, the processor 111 and the storage 102, 112 are included in a mobile terminal device 100, and the battery remaining capacity information is sent from the electric vehicle 1 to the mobile terminal device 100 by wireless communication.

The mobile terminal device 100 executes a process of determining whether or not to issue the first notification. This makes it unnecessary to mount the device executing such a process on the electric vehicle 1.

In the notification system 10, the notifier 105, 106 includes a display 105, and the processor 111 is configured or programmed to cause the display 105 to display at least one of a letter or a graphic pattern as the first notification urging the user to charge the battery 20.

With this arrangement, the user looks at the display contents of the display 105 and thus may keep in mind that he/she has to charge the battery 20 when arriving at the predetermined point 125.

In the notification system 10, the notifier 105, 106 includes a sound production component 106, and the processor 111 is configured or programmed to cause the sound production component 106 to output a sound as the first notification urging the user to charge the battery 20.

With this arrangement, the user hears the sound output by the sound production component 106 and thus may keep in mind that he/she has to charge the battery 20 when arriving at the predetermined point 125.

In the notification system 10, the predetermined point 125 is a point where a charging device charging the battery 20 is located.

With this arrangement, the battery 20 may be charged at the predetermined point 125.

In the notification system 10, the electric vehicle 1 is an electrically assisted bicycle including an electric motor 32 supplied with an electric current from the battery 20 to generate assist power.

With this arrangement, the user may keep in mind that he/she has to charge the battery 20 of the electrically assisted bicycle 1 when arriving at the predetermined point 125.

In the notification system 10, the battery 20 is a portable battery detachable from the electric vehicle 1.

With this arrangement, the battery 20 may be charged in a state of being detached from the electric vehicle 1.

A notification method for issuing a notification urging a user to charge a battery 20 of an electric vehicle 1, the notification method being executable by at least one computer and including acquiring first border information representing a first border 141 between a first area 131, encompassing a predetermined point 125 where the battery 20 is chargeable, and an area outward of the first area 131; acquiring positional information representing a current position of the electric vehicle 1 and battery remaining capacity information representing a battery remaining capacity of the battery 20; and in a case where it is determined that the electric vehicle 1 is located inside the first area 131 and that the battery remaining capacity of the battery 20 is not larger than a first threshold value based on the first border information, the positional information, and the battery remaining capacity information, issuing a first notification via a notifier 105, 106 urging the user to charge the battery 20.

In the case where the battery remaining capacity is not larger than the first threshold value, the first notification urging the user to charge the battery 20 may be issued at the timing when the electric vehicle 1 gets close to the predetermined point 125 where the battery 20 is chargeable. This allows the user to keep in mind that he/she has to charge the battery 20 when arriving at the predetermined point 125.

If the first notification is issued when the electric vehicle 1 arrives at the predetermined point 125, the following may occur. If the actual position of the electric vehicle 1 is deviated from the position represented by the positional information, the first notification may not be issued even though the electric vehicle 1 arrives at the predetermined point 125. According to an example embodiment of the present invention, the first notification is issued while the electric vehicle 1 is located inside the first area 131, which has a large area. Therefore, even if the actual position of the electric vehicle 1 is deviated from the position represented by the positional information, the first notification may be issued.

The first notification is issued in the case where the battery remaining capacity is not larger than the first threshold value so that the uneasiness that the user feels regarding the possibility that the battery remaining capacity becomes zero without him/her noticing may be alleviated.

A non-transitory computer readable medium including a computer program to cause at least one computer to issue a notification urging charging of a battery 20 of an electric vehicle 1, the computer program causing the at least one computer to acquire first border information representing a first border 141 between a first area 131, encompassing a predetermined point 125 where the battery 20 is chargeable, and an area outward of the first area 131; acquire positional information representing a current position of the electric vehicle 1 and battery remaining capacity information representing a battery remaining capacity of the battery 20; and in a case where it is determined that the electric vehicle 1 is located inside the first area 131 and that the battery remaining capacity of the battery 20 is not larger than a first threshold value based on the first border information, the positional information, and the battery remaining capacity information, issue a first notification via a notifier 105, 106 urging the user to charge the battery 20.

In the case where the battery remaining capacity is not larger than the first threshold value, the first notification urging the user to charge the battery 20 may be issued at the timing when the electric vehicle 1 gets close to the predetermined point 125 where the battery 20 is chargeable. This allows the user to keep in mind that he/she has to charge the battery 20 when arriving at the predetermined point 125.

If the first notification is issued when the electric vehicle 1 arrives at the predetermined point 125, the following may occur. If the actual position of the electric vehicle 1 is deviated from the position represented by the positional information, the first notification may not be issued even though the electric vehicle 1 arrives at the predetermined point 125. According to an example embodiment of the present invention, the first notification is issued while the electric vehicle 1 is located inside the first area 131, which has a large area. Therefore, even if the actual position of the electric vehicle 1 is deviated from the position represented by the positional information, the first notification may be issued.

The first notification is issued in the case where the battery remaining capacity is not larger than the first threshold value so that the uneasiness that the user feels regarding the possibility that the battery remaining capacity becomes zero without him/her noticing may be alleviated.

A notification system 10 for issuing a notification about a battery 20 of an electric vehicle 1 to a user includes a processor 111; and a storage 102, 112 to store a computer program to control an operation of the processor 111, wherein, the processor 111 is configured or programmed to execute the computer program to acquire border information representing a border 142 located along an outer perimeter of a predetermined area 132 enclosing a predetermined point 125, where the battery 20 is chargeable, and positional information representing a current position of the electric vehicle 1; and in a case it is determined that the electric vehicle 1 has passed a position of the border 142 into an area outward of the predetermined area 132 from the predetermined area 132 based on the border information and the positional information, issue a notification via a notifier 105, 106 urging the user to move the electric vehicle 1 to the predetermined point 125.

In the case where the electric vehicle 1 gets far from the predetermined point 125, where the battery 20 is chargeable, the battery remaining capacity may undesirably become zero before the electric vehicle 1 arrives back at the predetermined point 125. In the case where the electric vehicle 1 has passed the position of the border 142 into the area outward of the predetermined area 132, a notification urging the user to move the electric vehicle 1 to the predetermined point 125 is issued. This allows the user to recognize that if the electric vehicle 1 is farther away from the predetermined point 125, the battery remaining capacity may possibly become zero before the electric vehicle 1 arrives back at the predetermined point 125.

In the notification system 10, the processor 111 is configured or programmed to acquire battery remaining capacity information representing a battery remaining capacity of the battery 20, calculate, based on the battery remaining capacity of the battery 20, a distance-to-empty D2, by which the electric vehicle 1 is able to travel with an output current from the battery 20, and set the position of the border 142 such that a distance D3 between the predetermined point 125 and the border 142 is shorter than the distance-to-empty D2.

With this arrangement, the possibility that the battery remaining capacity becomes zero before the electric vehicle 1 arrives back at the predetermined point 125 may be decreased.

In the notification system 10, the processor 111 is configured or programmed to change the position of the border 142 in accordance with a change in the battery remaining capacity of the battery 20.

With this arrangement, the border 142 may be set at the position suitable to the current battery remaining capacity of the battery 20.

In the notification system 10, the processor 111 is configured or programmed to set the position of the border 142 such that the distance D3 between the predetermined point 125 and the border 142 is at least about 0.3 times and at most about 0.7 times the distance-to-empty D2.

With this arrangement, the possibility that the battery remaining capacity becomes zero before the electric vehicle 1 arrives back at the predetermined point 125 may be decreased.

A notification method for issuing a notification about a battery 20 of an electric vehicle 1 to a user, the notification method being executable by at least one computer and including acquiring border information representing a border 142 located along an outer perimeter of a predetermined area 132 enclosing a predetermined point 125, where the battery 20 is chargeable, and positional information representing a current position of the electric vehicle 1; and in a case where it is determined that the electric vehicle 1 has passed a position of the border 142 into an area outward of the predetermined area 132 from the predetermined area 132 based on the border information and the positional information, issuing a notification via a notifier 105, 106 urging the user to move the electric vehicle 1 to the predetermined point 125.

In the case where the electric vehicle 1 gets far from the predetermined point 125, where the battery 20 is chargeable, the battery remaining capacity may undesirably become zero before the electric vehicle 1 arrives back at the predetermined point 125. In the case where the electric vehicle 1 has passed the position of the border 142 into the area outward of the predetermined area 132, a notification urging the user to move the electric vehicle 1 to the predetermined point 125 is issued. This allows the user to recognize that if the electric vehicle 1 is farther away from the predetermined point 125, the battery remaining capacity may possibly become zero before the electric vehicle 1 arrives back at the predetermined point 125.

A non-transitory computer readable medium including a computer program to cause at least one computer to issue a notification about a battery 20 of an electric vehicle 1, the computer program causing the at least one computer to acquire border information representing a border 142 located along an outer perimeter of a predetermined area 132 enclosing a predetermined point 125, where the battery 20 is chargeable, and positional information representing a current position of the electric vehicle 1; and in a case where it is determined that the electric vehicle 1 has passed a position of the border 142 into an area outward of the predetermined area 132 from the predetermined area 132 based on the border information and the positional information, issue a notification via a notifier 105, 106 urging the user to move the electric vehicle 1 to the predetermined point 125.

In the case where the electric vehicle 1 gets far from the predetermined point 125, where the battery 20 is chargeable, the battery remaining capacity may undesirably become zero before the electric vehicle 1 arrives back at the predetermined point 125. A notification urging the user to move the electric vehicle 1 to the predetermined point 125 is issued in the case where the electric vehicle 1 has passed the position of the border 142 into the area outward of the predetermined area 132. This allows the user to recognize that if the electric vehicle 1 is farther away from the predetermined point 125, the battery remaining capacity may possibly become zero before the electric vehicle 1 arrives back at the predetermined point 125.

Example embodiments of the present invention are especially useful in the fields of notification systems for electric vehicles.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A notification system for issuing a notification urging a user to charge a battery of an electric vehicle, the notification system comprising:
a processor; and
a storage to store a computer program to control an operation of the processor; wherein
the processor is configured or programmed to execute the computer program to:
acquire first border information representing a first border between a first area, encompassing a predetermined point where the battery is chargeable, and an area outward of the first area;
acquire positional information representing a current position of the electric vehicle and battery remaining capacity information representing a battery remaining capacity of the battery; and
in a case it is determined that the electric vehicle is inside the first area and that the battery remaining capacity is not larger than a first threshold value based on the first border information, the positional information, and the battery remaining capacity information, issue a first notification via a notifier urging the user to charge the battery.

2. The notification system of claim 1, wherein, in a case it is determined that the electric vehicle has passed a position of the first border into the first area from the area outward of the first area and that the battery remaining capacity is not larger than the first threshold value, the processor is configured or programmed to issue the first notification.

3. The notification system of claim 2, wherein, in a case it is determined that the electric vehicle has passed the position of the first border into the first area from the area outward of the first area and that the battery remaining capacity is larger than the first threshold value, the processor is configured or programmed to not issue the first notification.

4. The notification system of claim 3, wherein, in a case where the processor does not issue the first notification when the electric vehicle passes the position of the first border but later determines that the battery remaining capacity is decreased to a value not larger than the first threshold value while the electric vehicle is located inside the first area, the processor is configured or programmed to issue the first notification.

5. The notification system of claim 1, wherein at least a portion of the first border is spaced away from the predetermined point by a first distance.

6. The notification system of claim 5, wherein the first distance is about 50 meters or longer and about 200 meters or shorter.

7. The notification system of claim 5, wherein the first border defines a circle centered around the predetermined point on a map.

8. The notification system of claim 1, wherein
the battery remaining capacity is represented by SOC (State of Charge); and
the first threshold value is set to an SOC value of about 20% or higher and about 60% or lower.

9. The notification system of claim 1, wherein the processor is configured or programmed to:
acquire second border information representing a second border located along an outer perimeter of a second area enclosing the first area; and
in a case it is determined that the electric vehicle has passed a position of the second border into an area outward of the second area from the second area, issue a second notification via the notifier urging the user to move the electric vehicle to the predetermined point.

10. The notification system of claim 9, wherein the processor is configured or programmed to:
calculate, based on the battery remaining capacity, a second distance by which the electric vehicle is able to travel with an output current from the battery; and
set the position of the second border such that a third distance between the predetermined point and the second border is shorter than the second distance.

11. The notification system of claim 10, wherein the processor is configured or programmed to change the position of the second border in accordance with a change in the battery remaining capacity.

12. The notification system of claim 10, wherein the processor is configured or programmed to set the position of the second border such that the third distance is at least about 0.3 times and at most about 0.7 times the second distance.

13. The notification system of claim 1, wherein
the notifier is included in a mobile terminal device; and
the electric vehicle and the mobile terminal device communicate with each other by wireless communication.

14. The notification system of claim 1, wherein
the processor and the storage are included in a mobile terminal device; and
the battery remaining capacity information is sent from the electric vehicle to the mobile terminal device by wireless communication.

15. The notification system of claim 1, wherein
the notifier includes a display; and
the processor is configured or programmed to cause the display to display at least one of a letter or a graphic pattern as the first notification urging the user to charge the battery.

16. The notification system of claim 1, wherein
the notifier includes a sound production component; and
the processor is configured or programmed to cause the sound production component to output a sound as the first notification urging the user to charge the battery.

17. The notification system of claim 1, wherein the predetermined point is a point where a charging device to charge the battery is located.

18. The notification system of claim 1, wherein the electric vehicle is an electrically assisted bicycle including an electric motor supplied with an electric current from the battery to generate assist power.

19. The notification system of claim 1, wherein the battery is a portable battery detachable from the electric vehicle.

20. A notification method for issuing a notification to urge a user to charge a battery of an electric vehicle, the notification method being executable by at least one computer and comprising:
acquiring first border information representing a first border between a first area, encompassing a predetermined point where the battery is chargeable, and an area outward of the first area;
acquiring positional information representing a current position of the electric vehicle and battery remaining capacity information representing a battery remaining capacity of the battery; and
in a case where it is determined that the electric vehicle is located inside the first area and that the battery remaining capacity is not larger than a first threshold value based on the first border information, the positional information, and the battery remaining capacity information, issuing a first notification via a notifier urging the user to charge the battery.

21. A notification system for issuing a notification about a battery of an electric vehicle to a user, the notification system comprising:
a processor; and
a storage to store a computer program to control an operation of the processor; wherein
the processor is configured or programmed to execute the computer program to:
acquire border information representing a border located along an outer perimeter of a predetermined area enclosing a predetermined point where the battery is chargeable, and positional information representing a current position of the electric vehicle; and
in a case it is determined that the electric vehicle has passed a position of the border into an area outward of the predetermined area from the predetermined area based on the border information and the positional information, issue a notification via a notifier urging the user to move the electric vehicle to the predetermined point.

22. The notification system of claim 21, wherein the processor is configured or programmed to:
acquire battery remaining capacity information representing a battery remaining capacity of the battery;
calculate, based on the battery remaining capacity, a distance-to-empty by which the electric vehicle is able to travel with an output current from the battery; and
set the position of the border such that a distance between the predetermined point and the border is shorter than the distance-to-empty.

23. The notification system of claim 22, wherein the processor is configured or programmed to change the position of the border in accordance with a change in the battery remaining capacity.

24. The notification system of claim 22, wherein the processor is configured or programmed to set the position of the border such that the distance between the predetermined point and the border is at least about 0.3 times and at most about 0.7 times the distance-to-empty.
